(19) United States
(12) Patent Application Publication
(10) Pub. No.: US 2011/0227939 A1
(43) Pub. Date: Sep. 22, 2011

(54) IMAGE GENERATION DEVICE, IMAGE DISPLAY DEVICE, IMAGE GENERATION METHOD, IMAGE DISPLAY METHOD, IMAGE GENERATION PROGRAM, AND IMAGE DISPLAY PROGRAM

(75) Inventor: Kazunori Inoue, Tokyo (JP)

(73) Assignee: PANASONIC CORPORATION, Osaka (JP)

(21) Appl. No.: 12/672,004

(22) PCT Filed: Aug. 5, 2008
(86) PCT No.: PCT/JP2008/002116

§ 371 Date: Feb. 3, 2010

(30) Foreign Application Priority Data
Aug. 6, 2007 (JP) 2007-204808

(51) Int. Cl. G09G 5/02; G09G 5/00

(52) U.S. Cl. 345/589; 345/619

(57) ABSTRACT

Provided is an image generation device which can reduce the maximum time required until a preview image is displayed without narrowing the selection width of the image quality adjustment. The device includes an image quality parameter reduction object selection unit which selects at least one image quality adjustment content from preset image quality adjustment contents, an image quality parameter application unit which applies the image quality adjustment content selected by the image quality parameter reduction object selection unit to the given image data and performs image quality adjustment of the image data and a transmission/reception unit which transmits the image data subjected to the image quality adjustment by the image quality parameter application unit to the image display unit. When at least two of the image data subjected to the image quality adjustment by applying the image quality adjustment contents are displayed with the same or similar image quality in the image display device, the image quality parameter reduction object selection unit selects only one image quality adjustment content from the image quality adjustment contents applied to the image data.

### TECHNICAL FIELD

The present invention relates to an image generation apparatus, image display apparatus, image generation method, image display method, image generation program, and image display program for displaying image data applied to a plurality of image quality adjustment contents.

### BACKGROUND ART

In recent years, opportunities for a general user to handle digital images on an everyday basis have increased. This is because most images generated by image input devices—such as images captured by digital still cameras, images captured by image scanners, images captured from video frames, and so forth—are now digital images.

Distributing or outputting generated digital images to various image output devices is easy. For example, digital images can be displayed by an image display apparatus such as a personal computer display, television, or portable audiovisual player, or printed out by a printer. Furthermore, digital images can be transmitted to a distant location, distributed, and duplicated, using an information communication network such as the Internet.

Against this backdrop, various tools for adjusting digital image quality in line with a user's wishes (hereinafter referred to as “image quality adjustment tools”) have appeared on the market. Image quality adjustment tools have made it possible, for example, to adjust the quality of a digital image by specifying values of parameters provided in advance for image quality adjustment (hereinafter referred to as “image quality parameters”), such as lightness, color shade, chroma, contrast, sharpness, noise reduction, and so forth. Such image quality adjustment tools are already included in some commercially available image processing software such as Adobe's Photoshop (registered trademark) and Ichikawa Soft Laboratory's SILKYPIX (registered trademark).

However, it is difficult for a general user lacking specialized knowledge of image quality adjustment to judge with certainty how image quality parameter values should be set in order to obtain a desired image quality.

Thus, many image quality adjustment tools display a preview image giving an idea of an editing result to help the user with the task of setting image quality parameter values. A preview image is an image resembling an actual editing result when image quality parameter value settings received from the user are applied and showing an image data generated by a process easier than the actual editing The user can decide on a desired image quality while viewing a preview image, and finally obtain image data adjusted to the decided image quality. Technology for displaying a preview image is described in Patent Document 1, for example.

In the technology described in Patent Document 1, image reduction processing is performed on image data to be edited, after which image conversion processing is performed. Specifically, in image generation apparatus 10 according to Patent Document 1 shown in FIG. 1, reduction processing is performed by reduction processing section 16 of control section 12 on image data input via input/output interface 11, and the reduced image data is stored in storage section 13. Then, each time an image quality parameter value is specified by the user via operation section 15, image conversion processing based on the specified value is performed on the reduced image data by conversion processing section 17 of control section 12, and the image-converted reduced image data is displayed on display section 14 as a preview image.

Although a preview image does not necessarily precisely reproduce an editing result, using a preview image enables an editing result to be presented to the user in a shorter time than by displaying image data that has actually been processed and edited based on specified image quality parameters. Therefore, the use of a preview image enables overall work efficiency to be improved.

However, if the response time with respect to a user operation—that is, the time taken to display a preview image after image quality adjustment content has been specified by the user—is long, the effect of improving work efficiency through the use of a preview image is halved.

Thus, a technology that shortens response time is described in Patent Document 2, for example.

In the technology described in Patent Document 2, a plurality of image data for preview image use are generated and stored in memory beforehand. Specifically, in image generation apparatus 20 according to Patent Document 2 shown in FIG. 2, image adjustment processing section 22 executes a plurality of image processing operations corresponding to different image qualities on image data beforehand, and stores the obtained plurality of image data in image memory 23. Then, each time an image quality parameter value is specified by preview processing section 24 via controller 21, image generation apparatus 20 reads the corresponding image data from image memory 23 and displays it on monitor 25 as a preview image. By this means, image processing can be started prior to specification of an image quality parameter value by the user, making it possible to shorten the response time.
Patent Document 1: Japanese Patent Application Laid-Open No.2003-348335
Patent Document 2: Japanese Patent Application Laid-Open No.2002-204365

### DISCLOSURE OF INVENTION

### Problems to be Solved by the Invention

There is a market demand for implementation of an image quality adjustment tool function by online processing using the Internet or the like. This is due to a wish to reduce the processing load on a user device. With this kind of system, a user decides on image data to be an object of image quality adjustment, and preview image display processing is performed on the decided image data. In this case, also, it is of course desirable to shorten the time from an image data decision by the user to preview image display as much as possible.

However, a problem with the technology described in Patent Document 2 is that the time from an image data decision by the user to preview image display may be longer than the time required for preview image data to be generated for all image quality adjustment content choices.

If the number of image quality adjustment content choices is reduced, it is possible to shorten the maximum time until a preview image is displayed. However, if the number of image quality adjustment content choices is reduced, the image quality adjustment selection range is narrowed, and it may no longer be possible to adjust the image quality of a digital image in line with a user's wishes.

It is an object of the present invention to provide an image generation apparatus, image display apparatus, image generation method, image display method, image generation program, and image display program that enable the maximum time required until a preview image is displayed to be shortened without narrowing the image quality adjustment selection range insofar as this is possible.

### Means for Solving the Problem

An image generation apparatus of the present invention employs a configuration having: an image quality adjustment selection section that selects at least one image quality adjustment content from among a preset plurality of image quality adjustment contents; an image quality adjustment application section that applies the image quality adjustment content selected by the image quality adjustment selection section to provided image data and performs image quality adjustment of that image data; and a transmitting section that transmits image data on which image quality adjustment has been performed by the image quality adjustment application section to an image display apparatus; wherein the image quality adjustment selection section, when at least two of the image data on which image quality adjustment has been performed by applying the plurality of image quality adjustment contents can be displayed with identical or similar image quality by the image display apparatus, selects only one image quality adjustment content from the image quality adjustment contents applied to that image data.

An image display apparatus of the present invention employs a configuration having: a receiving section that receives image data transmitted from the above-described image generation apparatus; an adjustment content decision section that decides image quality adjustment content that should be applied to image data received by the receiving section from among the plurality of image quality adjustment contents; a display adjustment section that, when the receiving section has not received image data on which image quality adjustment has been performed by applying image quality adjustment content decided by the adjustment content decision section, performs display adjustment on image data received by the receiving section by applying display adjustment content displays with image quality identical or similar to image quality when image quality adjustment is performed by applying image quality adjustment content decided by the adjustment content decision section; and an image display section that displays image data that has undergone display adjustment by the display adjustment section.

An image generation method has: an image quality adjustment selection step of selecting at least one image quality adjustment content from among a preset plurality of image quality adjustment contents; an image quality adjustment application step of applying the image quality adjustment content selected in the image quality adjustment selection step to provided image data and performing image quality adjustment of that image data; and a transmitting step of transmitting image data on which image quality adjustment has been performed in the image quality adjustment application step to an image display apparatus; wherein the image quality adjustment selection step, when at least two of the image data on which image quality adjustment has been performed by applying the plurality of image quality adjustment contents can be displayed with identical or similar image quality by the image display apparatus, selects only one image quality adjustment content from the image quality adjustment contents applied to that image data.

An image display method of the present invention has: a receiving step of receiving image data transmitted from the above-described image generation apparatus; an adjustment content decision step of deciding image quality adjustment content that should be applied to image data received in the receiving step from among the plurality of image quality adjustment contents; a display adjustment step of, when image data on which image quality adjustment has been performed by applying image quality adjustment content decided in the adjustment content decision step has not been received in the receiving step, performing display adjustment on image data received in the receiving step by applying display adjustment content displays with image quality identical or similar to image quality when image quality adjustment is performed by applying image quality adjustment content decided in the adjustment content decision step; and an image display step of displaying image data that has undergone display adjustment in the display adjustment step.

### Advantageous Effects of Invention

The present invention enables the maximum time required until a preview image is displayed to be shortened without narrowing the image quality adjustment selection range insofar as this is possible.

### BRIEF DESCRIPTION OF DRAWINGS

FIG. 1 is a block diagram showing a configuration of a conventional image generation apparatus;

FIG. 2 is a block diagram showing a configuration of a conventional image generation apparatus;

FIG. 3 is a system configuration diagram showing a configuration of an image processing system including an image generation apparatus according to Embodiment 1 of the present invention;

FIG. 4 is a block diagram showing a configuration of an image generation apparatus according to Embodiment 1;

FIG. 5 is a drawing showing an example of the data configuration of an input image in Embodiment 1;

FIG. 6 is a drawing showing an example of the contents of an adjustment range table in Embodiment 1;

FIG. 7 is a drawing showing examples of the contents of reduction object tables in Embodiment 1;

FIG. 8 is a drawing showing examples of the contents of default value tables in Embodiment 1;

FIG. 9 is a flowchart showing an example of the operation flow of an image generation apparatus according to Embodiment 1;

FIG. 10 is a flowchart showing an example of the flow of list creation processing in Embodiment 1;

FIG. 11 is a flowchart showing actual processing contents in list creation processing in Embodiment 1;

FIG. 12 is a block diagram showing a configuration of an image display apparatus according to Embodiment 2 of the present invention;

FIG. 13 is a drawing showing an example of the contents of an image collection and accompanying image quality parameter information in Embodiment 2;

FIG. 14 is a drawing showing an example of the configuration of a user interface in Embodiment 2;

FIG. 15 is a drawing showing an example of the contents of a display adjustment reference table in Embodiment 2;

FIG. 16 is a flowchart showing an example of the operation flow of an image display apparatus according to Embodiment 2;

FIG. 17 is a block diagram showing a configuration of an image generation apparatus according to Embodiment 3 of the present invention;

FIG. 18 is a drawing showing schematically the principle of color gamut maximization in Embodiment 3;

FIG. 19 is a drawing showing examples of the contents of reduction object tables in Embodiment 3;

FIG. 20 is a drawing showing an example of the contents of adjustment range information in Embodiment 3;

FIG. 21 is a flowchart showing an example of the operation flow of an image display apparatus according to Embodiment 3;

FIG. 22 is a flowchart showing an example of the flow of default value decision processing in Embodiment 3;

FIG. 23 is a flowchart showing an example of the specific processing flow of default value decision processing in Embodiment 3;

FIG. 24 is a block diagram showing a configuration of an image display apparatus according to Embodiment 4 of the present invention;

FIG. 25 is a drawing showing the contents of linear correspondence reference tables in Embodiment 4; and

FIG. 26 is a flowchart showing an example of the operation flow of an image display apparatus according to Embodiment 4.

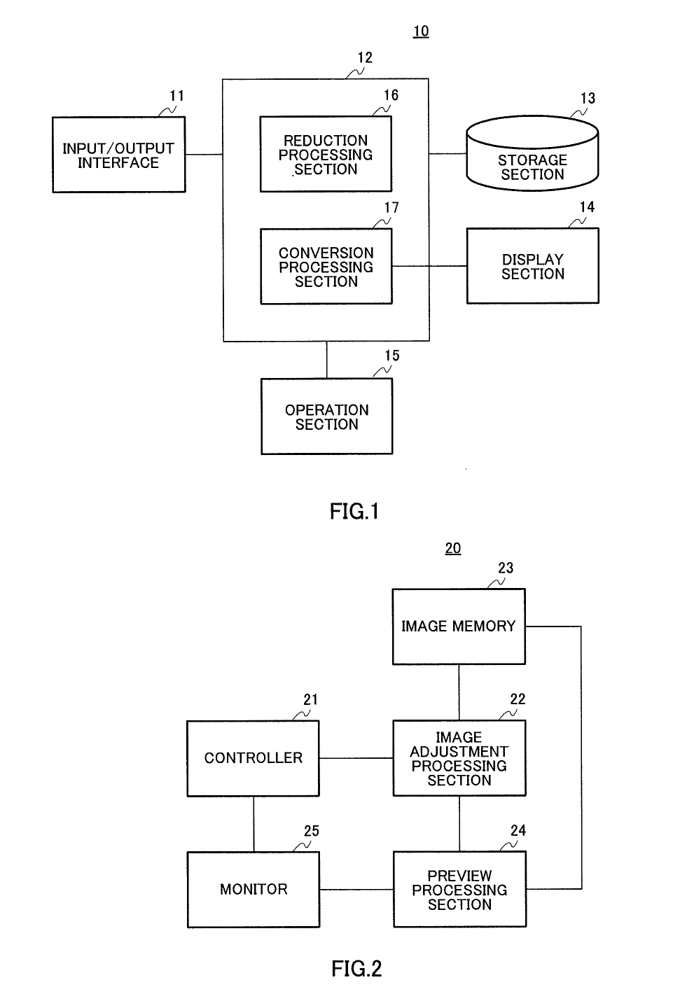

### BEST MODE FOR CARRYING OUT THE INVENTION

Now, embodiments of the present invention will be described in detail with reference to the accompanying drawings.

### Embodiment 1

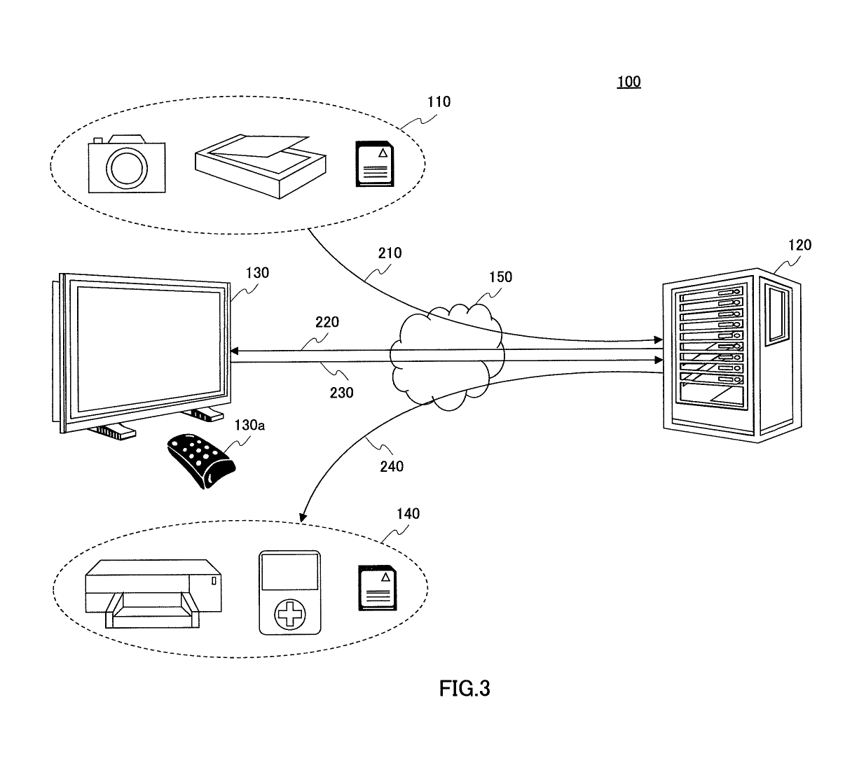

FIG. 3 is a system diagram showing a configuration of an image processing system including an image generation apparatus according to Embodiment 1 of the present invention. Here, the present invention will be described taking a case in which a user executes desired image quality adjustment on image data input by an image input device such as a camera by means of linkage between a home television receiver and a server connected via an information communication network as an example.

In FIG. 3, image processing system 100 has image input device group 110, image generation apparatus 120, image display apparatus 130, image output device group 140, and information communication network 150. This image processing system 100 is a system in which a processing entity that performs image quality adjustment and a processing entity that displays a preview image in response to a user request are separated into image generation apparatus 120 and image display apparatus 130.

Image input device group 110 comprises, for example, image input devices such as a camera and image scanner, and a recording medium such as a memory card. Image generation apparatus 120 is a computer device represented by server device that performs image data processing editing, and also generation of an image element that is image data forming the basis of a preview image. Image input device group 110 may also comprise a receiver, set-top box, video recorder, game machine, and so forth, connected to a television.

Here, an image element is an image resembling an image quality adjustment processing editing result, and refers to image data forming the basis of a preview image that is an aid to deciding image quality adjustment content that is the aim of a user by means of visual judgment. The format of an image element is a general-purpose image data format such as a JPEG or bitmap format, for example.

Image display apparatus 130 is a television provided with information communication network connection capability (a so-called “Net TV”), installed in a user's home, for instance.

Image output device group 140 comprises, for example, image output devices such as a printer and image viewer, and a recording medium such as a memory card.

Information communication network 150 is, for example, the Internet.

Image input device group 110, image display apparatus 130, and image output device group 140 are connected to image generation apparatus 120 via information communication network 150 so that communication is enabled. In image processing system 100, through linkage between image generation apparatus 120 and image display apparatus 130, image data stored by image input device group 110 is adjusted in line with a user's wishes, and is output or recorded by image output device group 140.

Image input device group 110 stores image data input from outside or image data generated from a captured image. When transmission of image data stored by image input device group 110 to image generation apparatus 120 is ordered by a user operation or the like while image input device group 110 is connected to a communication terminal (not shown), that image data is transmitted to image generation apparatus 120 as input image 210 via information communication network 150. Provision may also be made for image input device group 110 to transmit input image 210 to image generation apparatus 120 via image display apparatus 130.

Image generation apparatus 120 stores beforehand image quality adjustment content choices (hereinafter referred to as “adjustment choices”) assuming various kinds of image display apparatuses. Then image generation apparatus 120 generates an image element forming the basis of a preview image by applying an adjustment choice resulting from reducing the adjustment choices stored beforehand to input image 210. This adjustment choice reduction will be described later herein.

Image generation apparatus 120 transmits various kinds of data to image display apparatus 130 as download data 220, and receives various kinds of data from image display apparatus 130 as upload data 230. Image generation apparatus 120 receives from image display apparatus 130 information indicating image quality adjustment content specified by the user with the aim of preview image display (hereinafter referred to as “image quality specification information”). Then image generation apparatus 120 transmits a corresponding image element to image display apparatus 130 according to the received image quality specification information. Also, image generation apparatus 120 receives from image display apparatus 130 information indicating image quality adjustment content finally decided by the user (hereinafter referred to as “image quality decision information”). Then image generation apparatus 120 generates target image 240 comprising image data resulting from applying corresponding image quality adjustment content to input image 210 according to the received image quality specification information. Image generation apparatus 120 transmits generated target image 240 to image output device group 140 connected to a communication terminal (not shown), via information communication network 150.

Instead of transmitting one image element at a time to image display apparatus 130 according to image quality specification information, image generation apparatus 120 may transmit output images comprising a plurality of image elements en bloc.

Based on received download data 220, image display apparatus 130 generates a user interface for image quality adjustment content specification and decision by the user on its display screen. Then image display apparatus 130 accepts a user operation by means of remote controller 130a via the generated user interface. And image generation apparatus 120 transmits a corresponding image element according to received image quality specification information to image display apparatus 130. Image display apparatus 130 then displays an image element sent in response to transmitted image quality specification information on the user interface as a preview image, generates image quality specification information and image quality decision information according to a user operation, and transmits these to image generation apparatus 120. Remote controller 130a communicates with image display apparatus 130 by means of infrared, radio, or suchlike wireless communication, or wire communication via a cable. An operation section integral to image display apparatus 130 may be provided instead of remote controller 130a.

When output images comprising a plurality of image elements are received en bloc, image display apparatus 130 stores the received output images, obtains an image element corresponding to image quality adjustment content specified by the user, and displays this.

While connected to a communication terminal (not shown), image output device group 140 receives target image 240 from image generation apparatus 120 via information communication network 150. Image output device group 140 stores received target image 240 or visualizes it by displaying or printing. Provision may also be made for image output device group 140 to receive target image 240 from image generation apparatus 120 via image display apparatus 130.

In image processing system 100 with this kind of configuration, a plurality of image elements having different image qualities are generated en bloc by image generation apparatus 120 for image data possessed by a user. Then image quality adjustment content that is the aim of the user is decided via preview image switching display by image display apparatus 130. Target image 240 is then generated by image generation apparatus 120 in accordance with the decision result, and is passed to image output device group 140.

In this embodiment, it is assumed that image quality adjustment is performed by means of image quality parameters that adjust six types of element: lightness, contrast, chroma, color temperature, sharpness, and noise reduction.

Lightness is an image quality parameter that indicates the lightness tendency of an overall image. Contrast is an image quality parameter that indicates the extent of lightness difference of an overall image. Chroma is an image quality parameter that indicates the vividness of colors. Color temperature is an image quality parameter that indicates the color shade of an image. Sharpness is an image quality parameter that indicates the degree of contour enhancement of an image. Noise reduction is an image quality parameter that indicates the degree of elimination of noise components. The above-mentioned adjustment choices are a pattern of combinations of choices of these image quality parameters.

The configuration and operation of image generation apparatus 120 according to this embodiment will now be described in greater detail. First, the configuration of image generation apparatus 120 will be described.

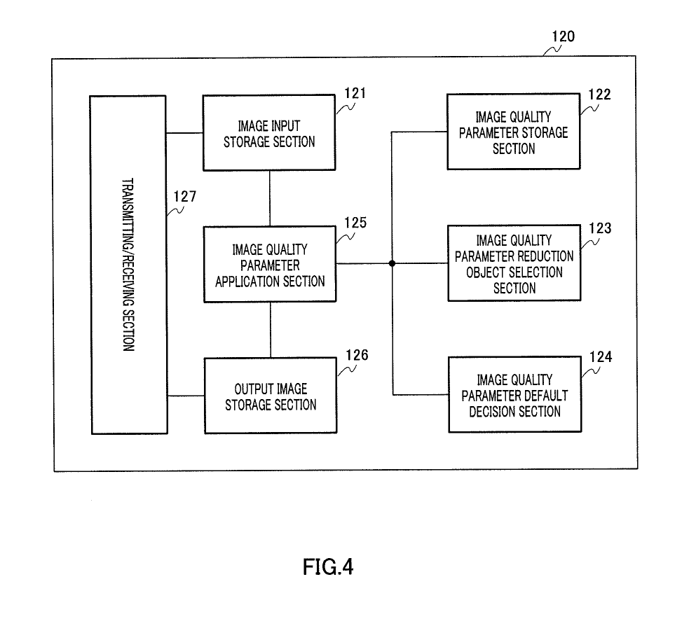

FIG. 4 is a block diagram showing the configuration of image generation apparatus 120.

In FIG. 4, image generation apparatus 120 has image input storage section 121, image quality parameter storage section 122, image quality parameter reduction object selection section 123, image quality parameter default decision section 124, image quality parameter application section 125, output image storage section 126, and transmitting/receiving section 127.

Image input storage section 121 stores input image 210 received from image input device group 110 by transmitting/receiving section 127 described later herein. The data format of input image 210 is general-purpose image data, such as data conforming to JPEG (joint photographic experts group) or TIFF (tagged image file format) widely used as standards, or RAW data created by adding various kinds of capture-time information to signal data recorded by the image sensor of a digital still camera, for example. In the following description, input image 210 will be assumed to be RAW data of an image captured by a digital still camera (hereinafter referred to simply as “camera”).

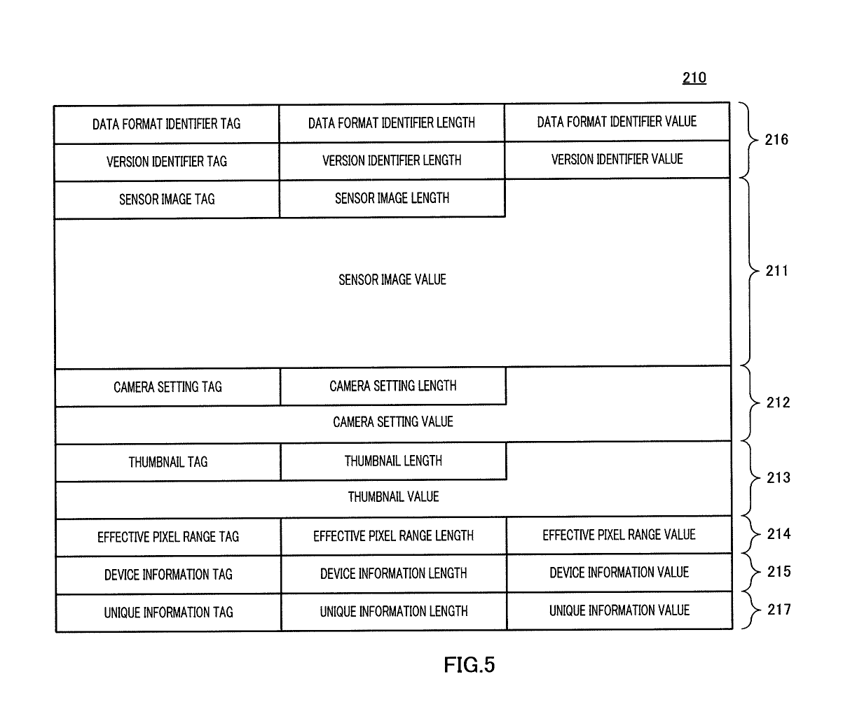

FIG. 5 is a drawing showing an example of the data configuration of input image 210 in the case of RAW data.

As shown in FIG. 5, input image 210 includes sensor image information 211, camera setting information 212, thumbnail information 213, effective pixel range information 214, device information 215, format information 216, and unique information 217.

Sensor image information 211 is image information captured by the image sensor of a camera. Sensor image information 211 should preferably be information prior to image processing inside a camera. Sensor image information 211 may also be information in which part or all of image information captured by the image sensor of a camera has been compressed using a heretofore known encoding technology.

Camera setting information 212 is information indicating camera setting contents at the time of shooting (image capture), such as the shooting date, shooting mode, sensitivity, aperture value, shutter speed, use of flash, and so forth. Camera setting information 212 may conform to or resemble EXIF (exchangeable image file format) information, for example. EXIF information is a general-purpose image format whose specifications have been drawn up by JEITA (Japan Electronics and Information Technology Industries Association).

Thumbnail information 213 is image information for easy confirmation of standard development results. Effective pixel range information 214 is information specifying the effective pixel range of sensor image information 211. Device information 215 is camera and lens related information. Format information 216 is information indicating the data format type and version. Unique information 217 is other unique information.

The above kinds of information are recorded and used as a file, using file system technology generally known in the computer field. As the internal file data structure, for example, a TLV format can be employed in which combinations of a tag (Tag) indicating the information type, information length (Length), and information content (Value), are linked for the required number of information items. Most RAW data conforms to a data format formulated independently by an individual camera manufacturer, and therefore the format of input image 210 is not limited to the above-described contents.

Image quality parameter storage section 122 in FIG. 4 stores an adjustment range table beforehand. An adjustment range table comprises information stipulating image quality parameter value choices (hereinafter referred to as “value choices”) for each image quality parameter used in input image 210 processing editing.

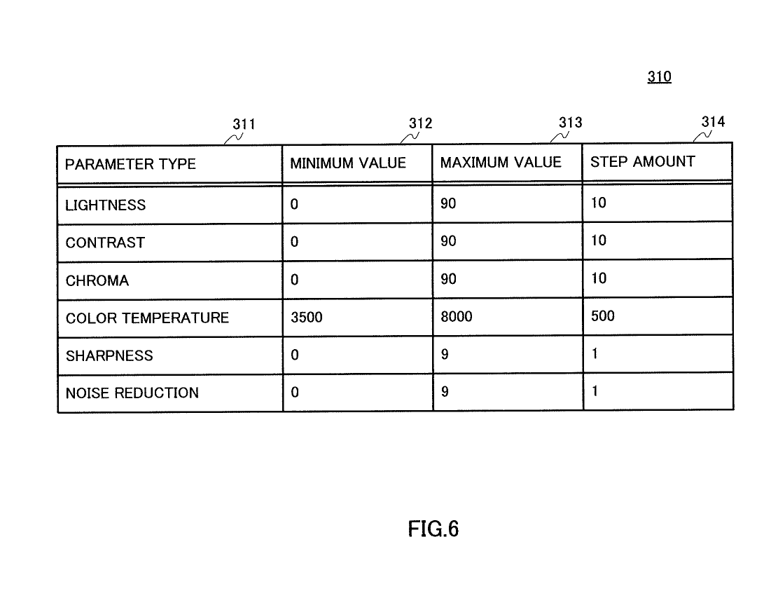

FIG. 6 is a drawing showing an example of the contents of an adjustment range table.

As shown in FIG. 6, adjustment range table 310 comprises parameter type 311, minimum value 312, maximum value 313, and step amount 314.

Under parameter type 311, six image quality parameter types—“lightness”, “contrast”, “chroma”, “color temperature”, “coloration”, “sharpness”, and “noise reduction”—are entered as image quality parameter types used in input image 210 processing editing.

Under minimum value 312, the minimum value that can be selected for an image quality parameter is entered, associated with that image quality parameter type. Under maximum value 313, the maximum value that can be selected for an image quality parameter is entered, associated with that image quality parameter type. Under step amount 314, the interval of a value that can be selected for an image quality parameter is entered, associated with that image quality parameter type.

The range from a minimum value 312 value to a maximum value 313 value is, for example, a range corresponding to a possible image quality adjustment range desired by a general user. A step amount 314 value is, for example, the minimum value of a difference in image quality parameter values for which a general user can recognize a difference in image quality. These values can be decided based on experimentation or experience.

For example, in adjustment range table 310 shown in FIG. 6, “0”, “90”, and “10” are entered respectively as minimum value 312, maximum value 313, and step amount 314, associated with parameter type 311 “lightness”. This stipulates ten possible values—“0, 10, 20, 30, 40, 50, 60, 70, 80, 90”—for an image quality parameter that affects the lightness of image data.

That is to say, a plurality of value choices are stipulated for each of the six types of image quality parameter. As image quality is decided by a combination of image quality parameter values, an enormous number of adjustment choices are stipulated by adjustment range table 310 as a whole.

If adjustment range table 310 shown in FIG. 6 is used directly, since values can be set in 10 steps for each image quality parameter, the total number of adjustment choices from combinations of the six types of image quality parameter is 10⁶—that is, one million. Assuming a generation time of 0.01 second for one image element, it would take approximately 2.8 hours to generate all image elements. Thus, a user would have to wait almost three hours before image quality adjustment was started on an image transmitted by the user. Such a system would be extremely user-unfriendly.

If step amount 314 is set to a larger value, the number of value choices and the number of adjustment choices decrease, and the time required until preview image display can be shortened. However, if step amount 314 is set to a larger value, there is a greater possibility of not being able to perform fine image quality adjustment, and of a user no longer being able to obtain a desired image quality.

Thus, image generation apparatus 120 of this embodiment reduces adjustment choices that are image element generation objects while keeping adjustment choices that should properly be presented. Specifically, whichever value choice is selected, image generation apparatus 120 reduces value choices that are image element generation objects to one default value for an image quality parameter such that image data is displayed with identical or similar image quality by an apparatus that displays preview images (here, image display apparatus 130). That is to say, a value choice is not provided for an image quality parameter such that a difference in display image quality cannot be recognized even if its value changes. By this means, the number of adjustment choices—that is, the number of generated image elements—is reduced, and the time required until preview image display is shortened.

For example, if value choices are eliminated for two of the six types of image quality parameter, and a singular default value is fixed for each, the total number of adjustment choices is reduced to 10⁴—that is, 10,000. Thus, in the case of a generation time of 0.01 second per image element, the time required to generate all image elements is shortened to 1.7 minutes.

Image quality parameter reduction object selection section 123 in FIG. 4 stores beforehand a reduction object table provided for each type of apparatus capable of performing preview image display (hereinafter referred to as “display apparatus”). A reduction object table comprises information that stipulates an image quality parameter type for which a contribution can be made to a reduction in the number of generated image elements by means of a reduction in value choices (hereinafter referred to as “reduction object”).

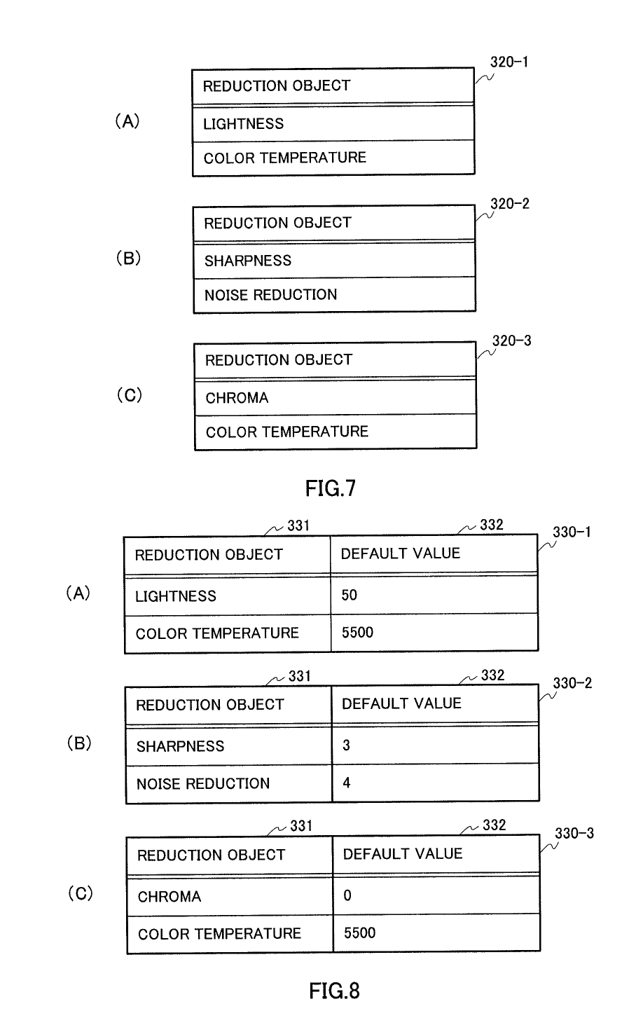

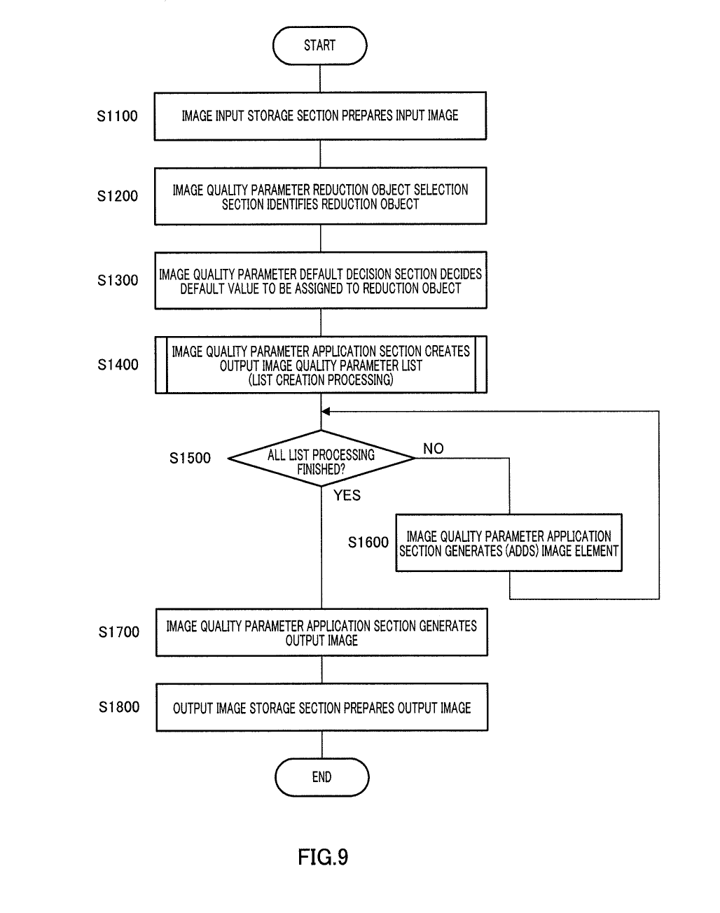

FIG. 7 (A) through FIG. 7 (C) are drawings showing examples of the contents of reduction object tables corresponding to different types of display apparatus.

As shown in FIG. 7, reduction objects are entered in each reduction object table 320. In reduction object table 320-1 shown in FIG. 7 (A) there are entered reduction objects when a television for which lightness and color temperature can be changed by image quality adjustment of a display image in image display apparatus 130 (hereinafter referred to as “display adjustment”) is made an image element transmission destination. In reduction object table 320-2 shown in FIG. 7 (B) there are entered reduction objects when a mobile phone in which a difference in sharpness or noise reduction is not represented because the display screen is small is made an image element transmission destination. In reduction object table 320-3 shown in FIG. 7 (C) there are entered reduction objects when a monochrome-display television is made an image element transmission destination.

For example, “lightness” and “color temperature” are entered as reduction objects in reduction object table 320-1 shown in FIG. 7 (A). This indicates that “lightness” and “color temperature” image quality parameters should be excluded from adjustment objects. That is to say, image quality parameters for which supplementation of corresponding image quality adjustment content is possible by means of display adjustment on the display apparatus side are entered in reduction object table 320-1 as reduction objects.

Also, for example, “sharpness” and “noise reduction” are entered as reduction objects in reduction object table 320-2 shown in FIG. 7 (B). This indicates that “sharpness” and “noise reduction” image quality parameters should be excluded from adjustment objects. That is to say, image quality parameters that are meaningless even if an image element is provided for each value choice on the transmitting apparatus side are entered in reduction object table 320-2 as reduction objects.

Image quality parameter reduction object selection section 123 in FIG. 4 references a reduction object table corresponding to a type of display apparatus (here, image display apparatus 130) that is an image element transmission destination and is actually used for preview image display, selects entered reduction objects, and outputs the selection results to image quality parameter application section 125.

Here, it is assumed that image display apparatus 130 shown in FIG. 3 is a display apparatus of a type corresponding to reduction object table 320-1 shown in FIG. 7 (A). In this case, image quality parameter reduction object selection section 123 selects “lightness” and “color temperature” as reduction objects from among the six types of image quality parameter shown in FIG. 6.

Reduction object selection by image quality parameter reduction object selection section 123 may also be implemented by execution of a program that gives an instruction to a computer resource, by control from outside, instead of by referencing data stored in table form such as shown in FIG. 7.

Image quality parameter default decision section 124 stores beforehand default value tables stipulating default values to be set for reduction objects for each type of display apparatus. Image quality parameter default decision section 124 references a default value table, decides a default value to be applied to a reduction object selected by image quality parameter reduction object selection section 123, and outputs the decision result to image quality parameter application section 125.

FIG. 8 (A) through FIG. 8 (C) are drawings showing examples of the contents of default value tables corresponding to different types of display apparatus.

As shown in FIG. 8, each default value table 330 comprises reduction object 331 and default value 332.

Under reduction object 331, an image quality parameter type that is a reduction object is entered. Under default value 332, a default value that should be applied is entered, associated with an image quality parameter type.

Default value tables 330-1 through 330-3 shown in FIG. 8 (A) through FIG. 8 (C) correspond respectively to the same display apparatus types as in reduction object tables 320-1 through 320-3 shown in FIG. 7.

For example, in default value table 330-1, the same image quality parameter types are entered as reduction objects 331 as in reduction object table 320-1. Also, in default value table 330-1, default value 332 “50” is entered associated with reduction object 331 “lightness”, and default value 332 “5500” is entered associated with reduction object 331 “color temperature”. This indicates that, for the corresponding display apparatus type, a value of 50 should be set when lightness has been selected as a reduction object, and a value of 5500 should be set when color temperature has been selected as a reduction object.

Reduction object tables 320 shown in FIG. 7 and default value tables 330 shown in FIG. 8 may be integrated and stored in a unified form by image quality parameter reduction object selection section 123 or image quality parameter default decision section 124.

Image quality parameter application section 125 shown in FIG. 4 stores beforehand processing content that generates image elements having similar image quality, assigned with respective adjustment choices. Image quality parameter application section 125 reads input image 210 stored in image input storage section 121, applies processing content corresponding to a combination of values of the above six types of image quality parameter to input image 210, and generates image elements. Then image input storage section 121 stores the generated image elements in output image storage section 126.

Specifically, image quality parameter application section 125 decides an adjustment choice to be applied to input image 210 from value choices of each image quality parameter stipulated by adjustment range table 310, a result of reduction object selection by image quality parameter reduction object selection section 123, and a result of default value decision by an image quality parameter default decision section 124. Image quality parameter application section 125 applies all decided adjustment choices individually, and generates a plurality of image elements in which simple image quality processing has been executed on input image 210. Then image quality parameter application section 125 generates an output image composed of the generated plurality of image elements, and stores the generated output image in output image storage section 126 in a state in which an individual image element is associated with image quality adjustment content applied to that image element.

The format of an output image generated by image quality parameter application section 125 should be, for example, a format in which encoding is performed into general-purpose image data such as MPEG (moving picture experts group) to enable many image elements to be handled efficiently. Methods of still-image to moving-image encoding that can be applied include a technology whereby still images are simply converted to moving image frames and linked, and various other kinds of encoding technology intended to improve image quality and reduce the amount of data. Here, it is assumed that one output image is generated for one input image 210.

Output image storage section 126 stores an output image stored by image quality parameter application section 125 in a state in which an individual image element is associated with image quality adjustment content.

Transmitting/receiving section 127 connects to information communication network 150, and performs communication with image input device group 110, image display apparatus 130, and image output device group 140 via information communication network 150. On receiving input image 210 from image input device group 110, transmitting/receiving section 127 stores received input image 210 in image input storage section 121. Also, when image quality specification information has been sent from image display apparatus 130, transmitting/receiving section 127 reads an image element corresponding to image quality adjustment content specified by that image quality specification information from output image storage section 126, and transmits this image element to image display apparatus 130. Furthermore, when image quality decision information has been sent from image display apparatus 130, transmitting/receiving section 127 executes image quality adjustment content indicated by that image quality decision information on input image 210 stored in image generation apparatus 120 and generates target image 240, and transmits generated target image 240 to image output device group 140.

If transmitting/receiving section 127 transmits output images to image display apparatus 130 en bloc, when output image storage in output image storage section 126 is completed, transmitting/receiving section 127 reads output images en bloc from output image storage section 126, and transmits them to image display apparatus 130.

Although not shown, image generation apparatus 120 has a CPU (central processing unit), a storage medium such as ROM (read only memory) that stores a control program, working memory such as RAM (random access memory), a communication circuit, and so forth. The functions of the above-described sections are implemented by execution of the control program by the CPU, for example.

The operation of image generation apparatus 120 having the above-described configuration will now be explained.

FIG. 9 is a flowchart showing an example of the operation flow of image generation apparatus 120 from input image 210 reception to image element preparation.

First, in step S1100, image input storage section 121 prepares input image 210. Specifically, image input storage section 121 stores input image 210 received by transmitting/receiving section 127 from image input device group 110, and places it in a state in which it can be passed to other related sections such as image quality parameter application section 125 in response to a request, or in a state in which it can be read by other sections. Then, when preparation of input image 210 is completed, image input storage section 121 reports this fact to other related sections.

Next, in step S1200, image quality parameter reduction object selection section 123 identifies an image quality parameter type that should be a reduction object in order to reduce the number of image elements generated as a preview image basis. Specifically, image quality parameter reduction object selection section 123 first acquires information indicating the type of image display apparatus 130 as a display apparatus (hereinafter referred to as “type information”) from upload data 230 or unique information 217 of input image 210. Then image quality parameter reduction object selection section 123 references reduction object table 320 corresponding to the acquired type information and acquires a reduction object, and reports the acquired reduction object to image quality parameter application section 125 and image quality parameter default decision section 124.

Then, in step S1300, image quality parameter default decision section 124 decides a default value to be assigned to a reduction object. Specifically, image quality parameter default decision section 124 references default value table 330 corresponding to reduction object table 320 used as a reference destination by image quality parameter reduction object selection section 123, and decides a default value of an image quality parameter that is a reduction object. Then image quality parameter default decision section 124 reports the decided default value to image quality parameter application section 125.

Next, in step S1400, image quality parameter application section 125 creates an output image quality parameter list (hereinafter referred to as “parameter list”) including all value choice combination patterns for each image quality parameter that should be applied to image element generation (hereinafter referred to simply as “combination patterns”). Specifically, image quality parameter application section 125 creates a combination pattern by applying all value choices entered in adjustment range table 310 for an image quality parameter other than a reduction object, and applying an input default value for a reduction object, and creates a parameter list. A parameter list may employ a data form in which combination patterns are listed, or may employ a data form in which combination patterns are output sequentially using a method whereby value combinations are generated sequentially by computer processing (such as a computer program). Processing that creates this parameter list will be described in detail later herein as list creation processing, using a separate drawing.

Then, in step S1500, image quality parameter application section 125 determines whether or not processing that generates an image element of an output image described later herein has been finished for all combination patterns of the parameter list. If an unprocessed combination pattern remains (S1500: NO), image quality parameter application section 125 proceeds to step S1600.

In step S1600, image quality parameter application section 125 generates (adds) an image element based on the parameter list. Specifically, image quality parameter application section 125 selects one combination pattern from the parameter list, applies processing content corresponding to the selected combination pattern to input image 210, and generates an image element. Then image quality parameter application section 125 stores the generated image element in memory or the like, and returns to step S1500.

Steps S1500 and S1600 are repeated, and when output-image image element generation processing is finished for all combination patterns in the parameter list, image quality parameter application section 125 proceeds to step S1700.

In step S1700, image quality parameter application section 125 generates an output image assembled by converting all image elements generated in step S1600 to a format that can be used by a general-purpose display apparatus (here, image display apparatus 130). Then image quality parameter application section 125 stores a generated output image in output image storage section 126. The output image format can be simply a collection of a plurality of images. Alternatively, if an image element is a JPEG image, the output image format may be made a general-purpose moving image format, such as an MPEG moving image format or Motion JPEG moving image format, by handling individual image elements as moving image frames. Also, image quality parameter application section 125 may add accompanying information indicating a combination pattern to an output image or individual image elements so as to facilitate later identification of which combination pattern an individual image element corresponds to.

Then, in step S1800, output image storage section 126 in which a new output image has been stored prepares an output image. Specifically, output image storage section 126 holds a stored output image, and places an image element or output image corresponding to image quality specification information in a state in which it can be transmitted speedily to image display apparatus 130.

In this way, a default value is applied for an image quality parameter for which the provision of value choices is unnecessary, and as a result, the number of generated image elements is reduced. By this means, the time required until generation of all image elements necessary for preview image display is completed after input image 210 is transmitted is shortened.

List creation processing by image quality parameter application section 125 will now be described in detail.

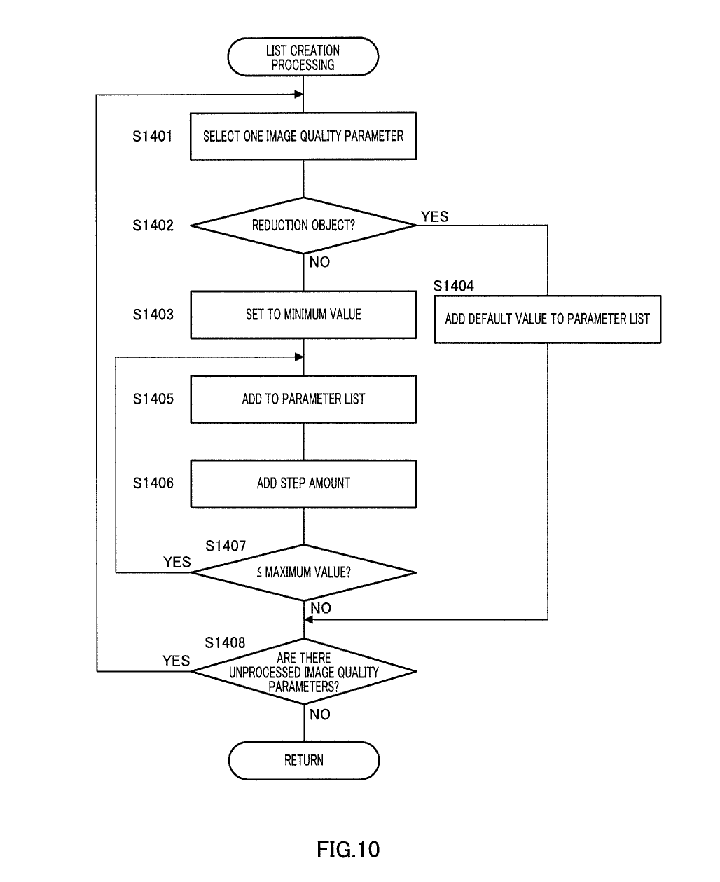

FIG. 10 is a flowchart showing an example of the flow of list creation processing by image quality parameter application section 125 (step S1400 in FIG. 9).

First, in step S1401, image quality parameter application section 125 selects one type of image quality parameter.

Then, in step S1402, image quality parameter application section 125 determines whether or not the selected image quality parameter is a reduction object. Image quality parameter application section 125 proceeds to step S1403 if the selected image quality parameter is not a reduction object (S1402: NO), or proceeds to step S 1404 if the selected image quality parameter is a reduction object (S1402: YES).

In step S1403, image quality parameter application section 125 sets the minimum value stipulated in adjustment range table 310 (see FIG. 6) for the selected image quality parameter.

Then, in step S1405, image quality parameter application section 125 adds the current value of the selected image quality parameter to the parameter list.

Next, in step S1406, image quality parameter application section 125 adds a step amount stipulated in adjustment range table 310 to the current value of the selected image quality parameter.

Then, in step S1407, image quality parameter application section 125 determines whether or not the current value of the selected image quality parameter is less than or equal to the maximum value stipulated in adjustment range table 310. If the current value of the selected image quality parameter is less than or equal to the maximum value stipulated in adjustment range table 310 (S1407: YES), image quality parameter application section 125 returns to step S1405, and repeats the processing until the above value exceeds the maximum value. By this means, image quality parameter application section 125 adds all possible values of the selected image quality parameter to the parameter list. If the current value of the selected image quality parameter exceeds the maximum value (S1407: NO), image quality parameter application section 125 proceeds to step S1408.

On the other hand, in step S1404, image quality parameter application section 125 adds a default value stipulated by image quality parameter default decision section 124 for the selected image quality parameter to the parameter list, and proceeds to step S1408. By this means, only a default value is added to the parameter list for a reduction object.

In step S1408, image quality parameter application section 125 determines whether or not unprocessed image quality parameter types remain. If image quality parameter types for which processing for addition to the parameter list has not been performed remain (S1408: YES), image quality parameter application section 125 returns to step S1401, selects one unprocessed image quality parameter type, and repeats the processing. On the other hand, if processing for addition to the parameter list has been completed for all image quality parameter types (S1408: NO), image quality parameter application section 125 returns to the processing in FIG. 9.

In this way, all possible values (but default values for reduction objects) are added to the parameter list for each image quality parameter. When all possible values have been acquired for each image quality parameter in this way, image quality parameter application section 125 can generate all combination patterns of possible values of each image quality parameter, and complete the parameter list.

Provision may also be made for image quality parameter application section 125 to generate combination patterns sequentially while changing the value of each image quality parameter. In this case, processing that successively changes a value for each image quality parameter type can be superimposed.

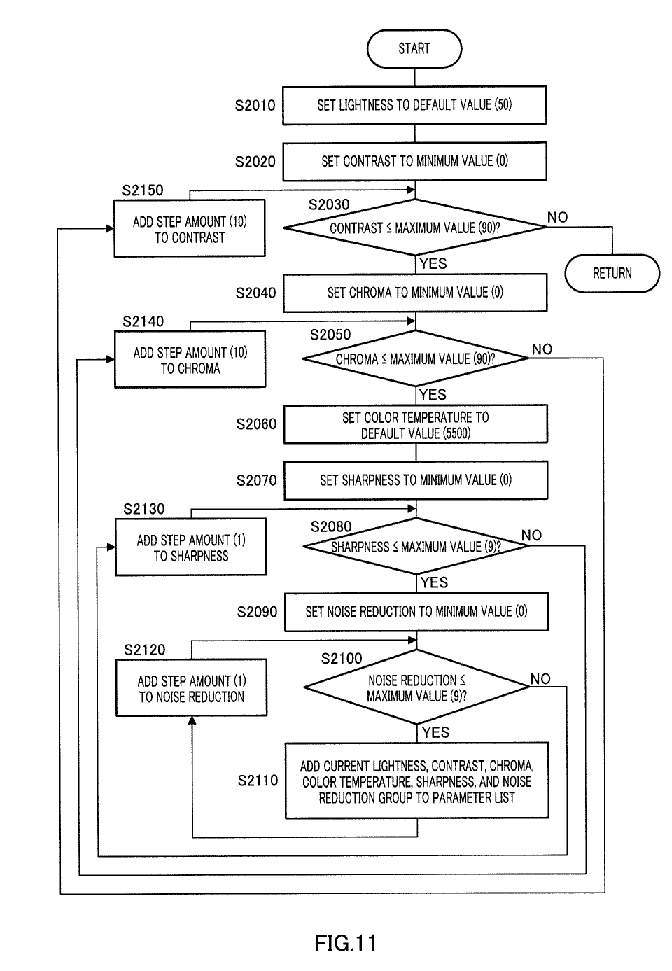

FIG. 11 is a flowchart showing an example of the actual processing flow in another example of list creation processing when reduction object table 320-1 shown in FIG. 7 is applied—that is, when lightness and color temperature are reduction objects.

First, in step S2010, since lightness is a reduction object, image quality parameter application section 125 sets default value 50 stipulated in adjustment range table 310 (see FIG. 6) for lightness.

Then, in step S2020, image quality parameter application section 125 sets minimum value 0 stipulated in adjustment range table 310 for contrast, and in step S2030 determines whether or not the current value of contrast is less than or equal to maximum value 90 stipulated in adjustment range table 310. If the current value of contrast is less than or equal to maximum value 90 (S2030: YES), in step S2040 image quality parameter application section 125 sets minimum value 0 stipulated in adjustment range table 310 for chroma.

Thereafter, in a similar way, image quality parameter application section 125 successively sets a default value for a reduction object, or a minimum value for an image quality parameter that is not a reduction object, for each image quality parameter (steps S2030 through S2100).

Then, in step S2110, image quality parameter application section 125 adds a combination of current values of lightness, contrast, chroma, color temperature, sharpness, and noise reduction to the parameter list.

Next, in step S2120, image quality parameter application section 125 adds step amount 1 stipulated in adjustment range table 310 to the current value of noise reduction, and returns to step S2100. Then image quality parameter application section 125 repeats the processing in steps S2100 through S2120, and if the noise reduction value exceeds the maximum (S2100: NO), proceeds to step S2130. In step S2130, image quality parameter application section 125 adds step amount 1 stipulated in adjustment range table 310 to the current value of sharpness, and returns to step S2080.

Thereafter, in a similar way, image quality parameter application section 125 changes a relevant image quality parameter value by a step amount each time processing passes through the same place, and then continues the same processing if the value is less than or equal to the maximum value. That is to say, image quality parameter application section 125 performs loop processing. When a maximum value is exceeded, image quality parameter application section 125 terminates the loop processing and repeats an outer loop (value change processing for another image quality parameter type).

In the innermost loop processing, a new combination pattern of each image quality parameter is added to the parameter list. As a result, in this example, 10,000 combination patterns are recorded in the parameter list. If reduction object selection and default deciding were not performed, one million combination patterns would be necessary, and thus it can be seen that the amount of processing necessary for parameter list creation is reduced to approximately one hundredth of that necessary in such a case.

Then, on terminating outermost loop processing (in this example, value change processing for contrast) (S2030: NO), image quality parameter application section 125 returns to the processing in FIG. 9.

In the actual implementation of processing shown in FIG. 11, a heretofore known multiple loop can be used in a computer program.

When executing the list creation processing shown in FIG. 11, image quality parameter application section 125 may also integrate steps S1500 and S1600 in FIG. 9 into the processing of step S2110, for example, and generate (add) image elements within the loop processing.

When an output image is prepared in this way, transmitting/receiving section 127 reads an image element of a corresponding output image from output image storage section 126 each time image quality specification information is sent from image display apparatus 130, and sends it back to image display apparatus 130. Alternatively, transmitting/receiving section 127 reads output images from output image storage section 126 and transmits these en bloc to image display apparatus 130. As a result, after transmitting input image 210, a user can speedily adjust the value of an image quality parameter while confirming the image quality of a preview image, and can finally specify an image quality parameter corresponding to a desired image quality.

Also, when image quality decision information is sent from image display apparatus 130, transmitting/receiving section 127 executes image quality adjustment content indicated by that image quality decision information on input image 210 stored in image input storage section 121, and generates target image 240. Then transmitting/receiving section 127 transmits generated target image 240 to image output device group 140. As a result, a user can speedily obtain target image 240 adjusted to a desired image quality by means of an operation with a short wait time while at home, without specially providing an image quality adjustment tool.

As described above, according to this embodiment, image data forming the basis of a preview image is generated by providing default values for image quality parameters such that image data is displayed by image display apparatus 130 with identical or similar image quality even if set values differ among image quality parameters. By this means, the number of image quality parameter value combinations can be reduced, and the number of generated image data forming the basis of a preview image can be greatly reduced, without narrowing the selection range of image quality adjustments that should properly be presented. Therefore, the amount of calculation and processing time necessary for output image generation can be greatly reduced, and the maximum time required until a preview image is displayed can be shortened without narrowing the image quality adjustment selection range insofar as this is possible.

Furthermore, it is not necessary for image display apparatus 130 itself on which a user displays a preview image to be equipped with a function for generating an image element or target image. Thus, a target image with an image quality desired by a user can be provided to the user without a special apparatus being provided on the user side, and without a processing load being particularly imposed on the user's apparatus. That is to say, the present invention enables both a reduction in processing time and distribution of processing, and is therefore particularly suitable for a system in which a processing entity that performs image quality adjustment and a processing entity that displays a preview image in response to a user request are separated.

### Embodiment 2

In Embodiment 2, at least some image quality adjustment choices that should properly be presented as preview images are implemented by display adjustment on the image display apparatus side.

In recent years, general image display apparatuses such as televisions have normally been provided with functions for adjusting the image quality of a display image, such as an adjustment function that changes lightness, an adjustment function that changes contrast, and so forth. Therefore, it is possible to reduce the number of generated image elements by supplementing image quality adjustment for preview image display by image generation apparatus 120 with display adjustment in an image display apparatus.

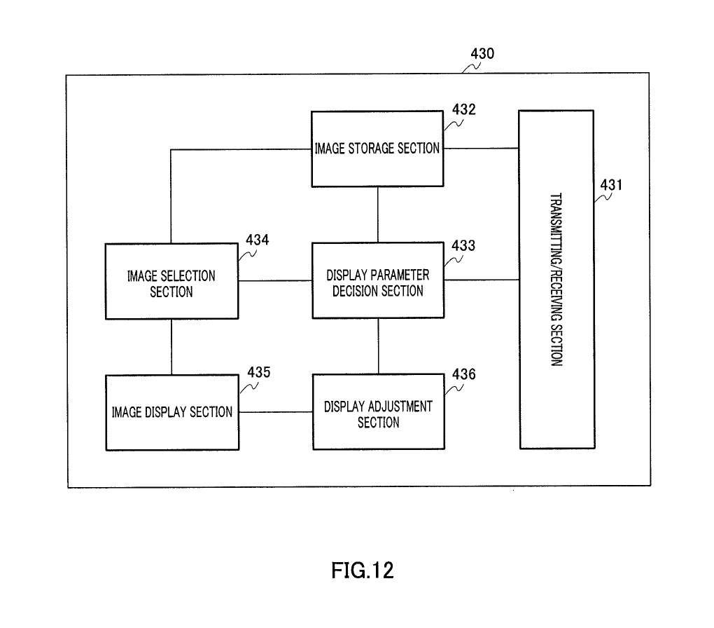

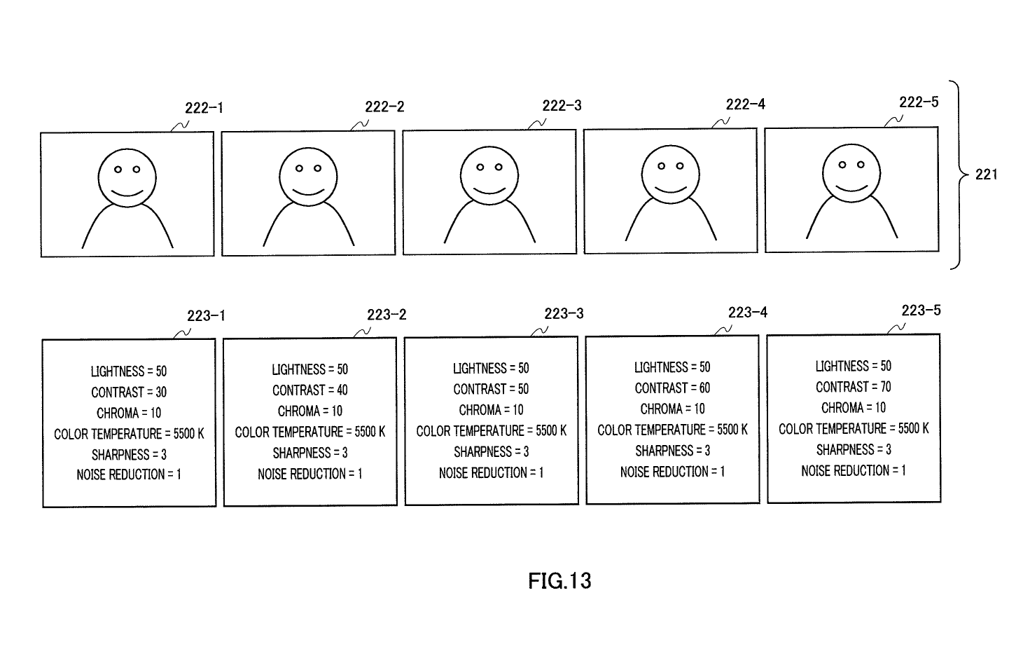

FIG. 12 is a block diagram showing a configuration of an image display apparatus according to this embodiment. Here, a case will be described in which an image display apparatus according to this embodiment is used as image display apparatus 130 of image processing system 100 of Embodiment 1. It is assumed that image generation apparatus 120 transmits a collection of image elements generated for preview image display (hereinafter referred to as “image collection”), and values of each image quality parameter corresponding to individual elements of that image collection (hereinafter referred to as “image quality parameter information”), to the image display apparatus.

In FIG. 12, image display apparatus 430 has transmitting/receiving section 431, image storage section 432, display parameter decision section 433, image selection section 434, image display section 435, and display adjustment section 436.

Transmitting/receiving section 431 connects to information communication network 150, and performs communication with image generation apparatus 120 of Embodiment 1, for example, via information communication network 150. On receiving an image collection and image quality parameter information accompanying this from image generation apparatus 120, transmitting/receiving section 431 stores the received image collection and image quality parameter information in image storage section 432 described later herein.

Image storage section 432 holds an image collection and image quality parameter information stored by transmitting/receiving section 431.

FIG. 13 is a drawing showing an example of the contents of an image collection and accompanying image quality parameter information.

As shown in FIG. 13, image collection 221 comprises plurality of image elements 222-1 through 222-5 with different image quality adjustment content. The most suitable example of an image collection is output images generated by image generation apparatus 120 shown in Embodiment 1. Image quality parameter information 223-1 through image quality parameter information 223-5 are associated with image elements 222-1 through 222-5 respectively as information indicating corresponding values of each image quality parameter. A heretofore known identification technology such as a predetermined data array order or numbering is used for this association.

Here, a case is illustrated in which default values 50, 10, 5500K, 3, and 1 are set respectively for lightness, chroma, color temperature, sharpness, and noise reduction image quality parameters, and a plurality of value choices are set only for contrast. In this case, if a user desires a preview image with lightness set to “80”, for example, there is no corresponding image element 222.

Thus, image display apparatus 130 adds an image element corresponding to image quality adjustment content closest to the image quality parameter values targeted for display by the user as a preview image. Then, by means of display adjustment, image display apparatus 130 brings the preview image closer to the image quality of a preview image that should properly be displayed.

Display parameter decision section 433 in FIG. 12 stores a table with the same contents as adjustment range table 310 (see FIG. 6) stored by image generation apparatus 120, and presents image quality parameter value choices stipulated by the table to the user. Then display parameter decision section 433 acquires image quality specification information indicating image quality adjustment content specified by the user, and decides upon image element 222 with which image quality parameter information 223 whose content is closest to the acquired image quality specification information as an image that should be read (hereinafter referred to as “preview use image”). Display parameter decision section 433 then outputs the decision result to image selection section 434, and also outputs the acquired image quality specification information, and information indicating image quality parameter information 223 corresponding to the preview use image (hereinafter referred to as “used parameter information”), to display adjustment section 436.

Specifically, display parameter decision section 433 generates a user interface for accepting image quality parameter value adjustments from the user, and displays this on the display. Then adjusted image quality parameter values are acquired via the user interface as image quality specification information.

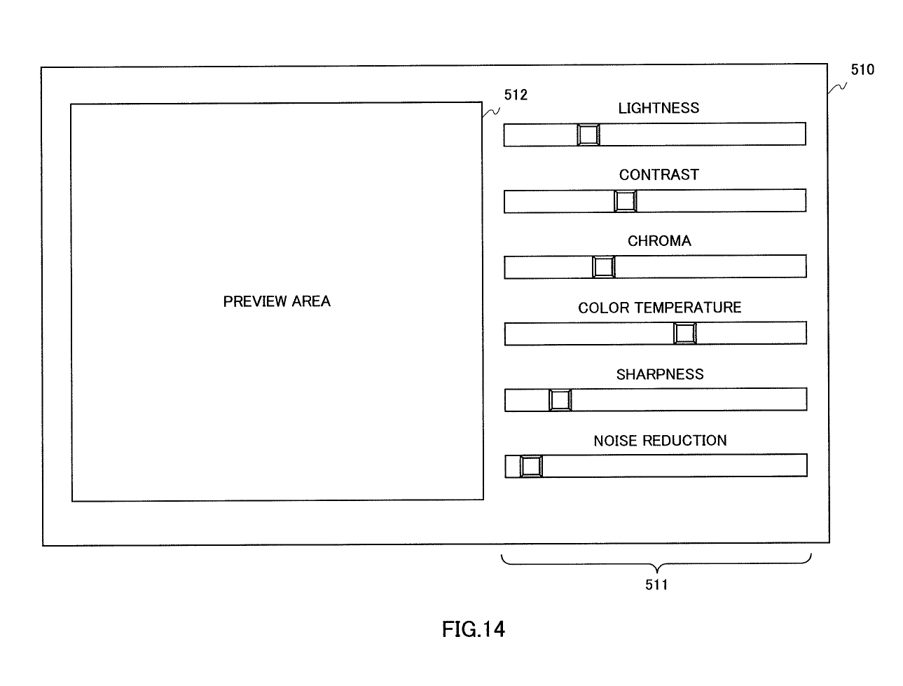

FIG. 14 is a drawing showing an example of the configuration of a user interface for accepting image quality parameter value adjustments.

As shown in FIG. 14, user interface 510 has image quality parameter specification area 511 for specifying image quality parameter values individually, and preview area 512 for displaying a preview image corresponding to image quality parameter values specified in image quality parameter specification area 511.

In image quality parameter specification area 511, a knob-shaped object (slider) positioned on top of a bar-shaped object extending horizontally is displayed for each image quality parameter. The value of each image quality parameter can be specified arbitrarily by moving a slider along a bar-shaped object in image quality parameter specification area 511.

Image quality parameter selection and slider movement are implemented, for example, by operation of a cross-shaped button that accepts up/down/left/right input provided on remote controller 130a in FIG. 3, or by operation of a pointing device such as a mouse widely used with personal computers. For example, display parameter decision section 433 can assign up/down operations to image quality parameter selection, and left/right operations to slider movement. Also, when discrete values are set as values that image quality parameters can be given, such as stipulated in adjustment range table 310 of image generation apparatus 120 (see FIG. 6), display parameter decision section 433 may restrict slider movement so that only set discrete values can be used.

When a decision operation such as depression of a Return key (not shown) is performed when an image quality parameter value has been specified in user interface 510, display parameter decision section 433 acquires content specified in user interface 510 as image quality specification information. Then display parameter decision section 433 transmits the acquired image quality specification information to image generation apparatus 120 via transmitting/receiving section 431.

Image selection section 434 in FIG. 12 selects and reads a preview use image decided by display parameter decision section 433 from image collection 221 stored by image storage section 432, and outputs this to image display section 435. For example, if an image collection is a JPEG image collection, image selection section 434 simply acquires corresponding image element 222. Alternatively, if an image collection is managed using a computer file system, image selection section 434 reads corresponding image element 222 as a file from a specified folder. Then again, if an image collection comprises moving images, image selection section 434 selects image element 222 from a moving image using a heretofore known technology that extracts part of a moving image as a still image—that is, a moving image capture technique.

Image display section 435 displays input image element 222 in preview area 512 of the user interface shown in FIG. 14.

Display adjustment section 436 performs display adjustment that compensates for a difference between image quality specification information and used parameter information on a preview image displayed in preview area 512 by image display section 435. Specifically, for image quality parameters for which display adjustment by display adjustment section 436 is possible, display adjustment section 436 stores beforehand a display adjustment reference table in which are entered, for each value difference, a display image quality adjustment value that provides a preview image with an image quality change equivalent to that difference. Then display adjustment section 436 calculates a difference between an image quality parameter value of an image quality specification information and an image quality parameter value of a used parameter information, references the display adjustment reference table, and decides a display image quality adjustment value to be applied to preview image display.

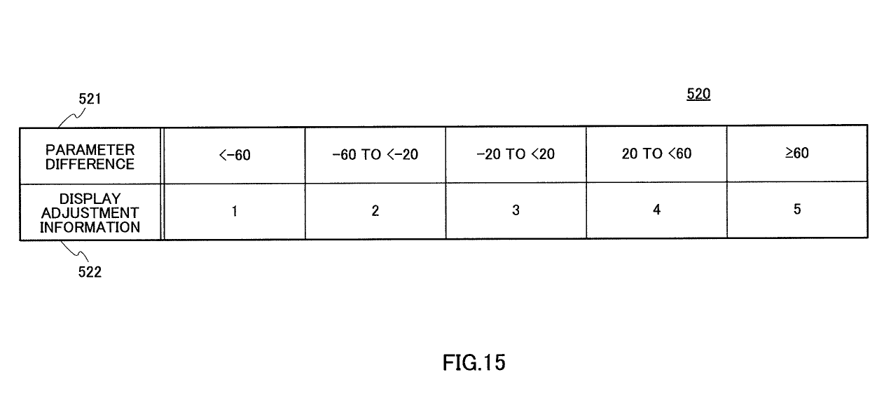

FIG. 15 is a drawing showing an example of the contents of a display adjustment reference table. Display adjustment section 436 has a display adjustment reference table for all image quality parameters for which display adjustment by display adjustment section 436 is possible and there is a possibility of being made a reduction object on the image generation apparatus 120 side. Here, only a display adjustment reference table for lightness is shown.

As shown in FIG. 15, lightness display adjustment reference table 520 comprises parameter difference 521 and display adjustment information 522. Parameter difference 521 is the difference between a target image quality parameter value and an image quality parameter value of an image element that is actually a display object. Display adjustment information 522 is information indicating an adjustment value of a parameter that decides display image quality, and is a value for compensating for parameter difference 521 and displaying a preview image with image quality corresponding to a target image quality parameter value. Display adjustment information 522 corresponding to parameter difference 521 can be decided based on experimentation or experience.

Although not shown, image display apparatus 430 has a CPU, a storage medium such as ROM that stores a control program, working memory such as RAM, a communication circuit, and so forth. The functions of the above-described sections are implemented by execution of the control program by the CPU, for example.

The operation of image display apparatus 430 having the above-described configuration will now be explained in detail.

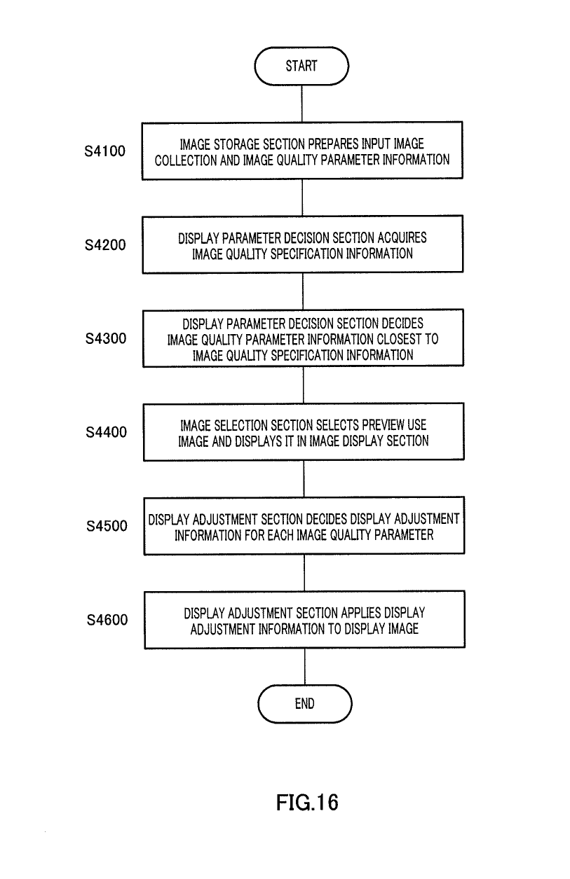

FIG. 16 is a flowchart showing an example of the operation flow of image display apparatus 430 from image collection 221 and image quality parameter information 223 reception to preview image switching and display.

First, in step S4100, image storage section 432 prepares input image collection 221 and image quality parameter information 223. Specifically, image storage section 432 stores image element 222 and image quality parameter information 223 received from image generation apparatus 120 by transmitting/receiving section 431. By this means, image storage section 432 places image element 222 and image quality parameter information 223 in a state in which they can be passed to other related sections or in a state in which they can be read by other related sections. Then, when the above preparation is completed, image storage section 432 reports this fact to other related sections.

Next, in step S4200, display parameter decision section 433 displays the user interface shown in FIG. 14, accepts image quality parameter value specifications from the user, and acquires a combination of specified values as image quality specification information.

Then, in step S4300, display parameter decision section 433 searches for image quality parameter information 223 with content closest to the acquired image quality specification information in image storage section 432, and decides upon corresponding image quality parameter information 223 as used parameter information. Display parameter decision section 433 then decides upon image element 222 corresponding to the used parameter information as a preview use image. Then display parameter decision section 433 reports the decided preview use image to image quality parameter application section 125, and also reports the acquired image quality specification information and the decided used parameter information to display adjustment section 436.

Methods such as described below, for example, can be used as a used parameter information deciding method. A first method is to subtract a used parameter information value from an image quality specification information value for each image quality parameter type, find a value resulting from dividing the subtraction value by the maximum adjustment range of that image quality parameter, and decide upon image quality parameter information 223 for which the total value of the image quality parameters is minimum. A second method, when slider movement is restricted in line with an image element generation presupposition as described above, is for image quality parameter information 223 for which a value difference for an image quality parameter decided upon as a reduction object by image generation apparatus 120 is minimum to be decided upon as used parameter information.

Image quality of image element 222 read as a preview use image is no more than image quality corresponding to image quality adjustment content closest to image quality specification information, and is not necessarily image quality corresponding to image quality specification information. That is to say, a preview use image, if displayed as it is, is not necessarily displayed with image quality identical or similar to image quality when a user-specified image quality parameter value is applied.

Next, in step S4400, image selection section 434 reads a preview use image decided by display parameter decision section 433 from image storage section 432, and displays it in image display section 435 as a preview image.

Then, in step S4500, display adjustment section 436 decides display adjustment information for each image quality parameter type. Specifically, display adjustment section 436 subtracts a used parameter information value from an image quality specification information value and finds a value difference for each image quality parameter type, references display adjustment reference table 520 of an image quality parameter for which there is a difference, and acquires corresponding display adjustment information 522.

For example, if a value specified for lightness by the user is 80, and received image elements are image elements 222-1 through 222-5 shown in FIG. 13, image quality parameter information 223 having the closest value for lightness is all of image quality parameter information 223-1 through image quality parameter information 223-5 for which lightness is “50”. In this case, whichever image quality parameter information 223 is decided upon as used parameter information, the subtraction result for lightness is 30, and “4” is acquired as lightness display adjustment information from lightness display adjustment reference table 520 shown in FIG. 15.

Next, in step S4600, display adjustment section 436 performs display-image image quality adjustment by applying the acquired display adjustment information. As a result, preview image display image quality is also adjusted. Display adjustment may be performed automatically, or may be performed by presenting an adjustment value that should be set to the user, and prompting manual adjustment by the user.

Thus, with image display apparatus 430, a preview image can be displayed with image quality identical or similar to image quality corresponding to image quality specification information by means of display adjustment even if there is no image element 222 corresponding to image quality specification information. By means of preview display (simple confirmation image display), a user can easily determine visually the general state of input image 210 sent to image generation apparatus 120 produced by user-specified image quality parameter values.

Then, when a decision operation is performed for an image quality parameter value via user interface 510 shown in FIG. 14, image display apparatus 430 transmits image quality decision information to image generation apparatus 120 as described above. As a result, target image 240 having image quality desired by the user is sent to image output device group 140 of Embodiment 1, for example.

As described above, in this embodiment, if there is no image element to which image quality adjustment content specified by a user has been applied among image elements received from image generation apparatus 120, an image element to which the closest image quality adjustment content has been applied is made a preview display object. Then, by means of display adjustment by image display apparatus 430, display adjustment content displays with image quality identical or similar image quality for which user-specified image quality adjustment content has been applied is applied to a preview image. By this means, an image quality adjustment range not applied to image elements received from image generation apparatus 120 is supplemented, and a result in line with the original preview image display intention can be approximately implemented. That is to say, preview display with image quality according to user-specified image quality adjustment content can be implemented even when the number of received image elements has been reduced, enabling the number of image elements that should be provided as image data forming the basis of a preview image to be reduced. Consequently, the maximum time required until a preview image is displayed can be shortened without narrowing the image quality adjustment selection range insofar as this is possible.

### Embodiment 3

In Embodiment 3, a default value for a reduction object is decided that enables an effective image quality adjustment range of a display apparatus (hereinafter referred to as “display range”) to be extended as much as possible, and reproducibility of image quality according to specified image quality adjustment content is improved.

Before describing an image generation apparatus of this embodiment, the principle of display range maximization according to this embodiment will be explained, taking a case in which a default value is set for a lightness image quality parameter as an example.

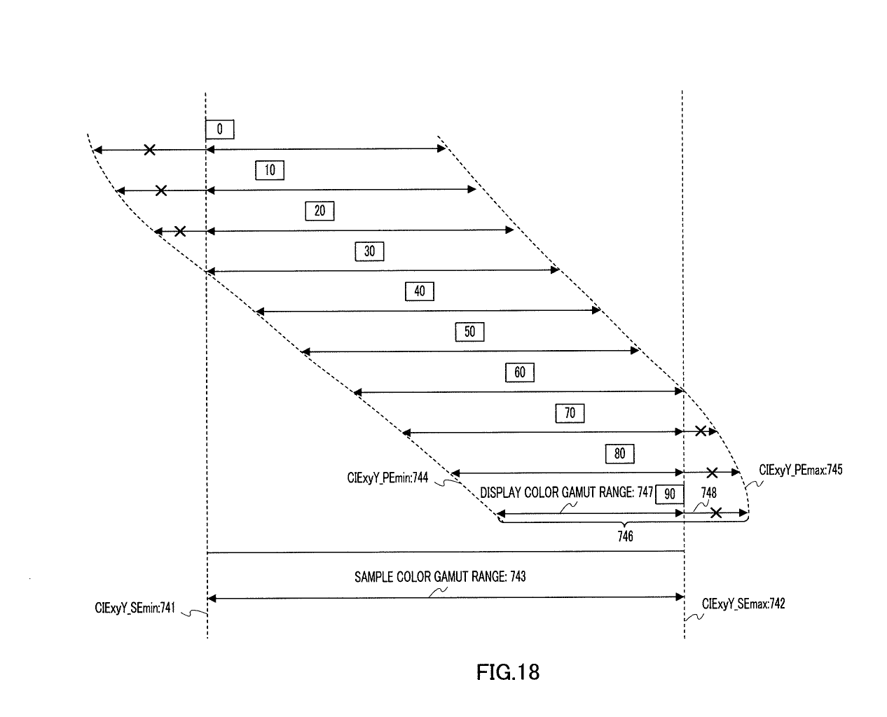

FIG. 18 is a drawing showing schematically the principle of color gamut maximization when a default value is set for a lightness image quality parameter.

In FIG. 18, sample lightness minimum value CIExyY_SEmin 741 is absolute lightness obtained when an image element generated from a standard image using the minimum value of a lightness image quality parameter (for example, “0”, the minimum value of lightness shown in FIG. 6) is displayed in a standard image quality setting state of a display apparatus. Sample lightness maximum value CIExyY_SEmax 742 is absolute lightness obtained when an image element generated from a standard image using the maximum value of a lightness image quality parameter (for example, “90”, the maximum value of lightness shown in FIG. 6) is displayed in a standard image quality setting state of a display apparatus. A standard image is an image in which a standard subject such as a gray card with a reflection coefficient of 18%, for example, has been photographed with camera settings and a light source that illuminates the subject set to standard values.

That is to say, sample color gamut range 743, which is the range from sample lightness minimum value CIExyY_SEmin 741 to sample lightness maximum value CIExyY_SEmax 742, indicates a color gamut range that is essentially wished to be displayed, and for which display is possible by a display apparatus. In other words, sample color gamut range 743 indicates a result range that should be reproduced when an image element is obtained by actually applying image quality parameters to a standard image.

In FIG. 18, numeric values inside boxes indicate examples of lightness default values. Display lightness minimum value CIExyY_PEmin 744 is lightness obtained as a result of displaying an image element generated by applying a default value to standard-image image data in a state in which a display apparatus setting is made so that lightness becomes minimum. Display lightness maximum value CIExyY_PEmax 745 is lightness obtained as a result of displaying an image element generated by applying a default value to standard-image image data in a state in which a display apparatus setting is made so that lightness becomes maximum.

That is to say, color gamut range 746 from display lightness minimum value CIExyY_PEmin 744 to display lightness maximum value CIExyY_PEmax 745 is a data color gamut range when a default value is applied to standard-image image data. How far sample color gamut range 743, which is a color gamut range that should ideally be covered, can be implemented, is decided by the size of display color gamut range 747, which is an effective display color gamut range.

However, in actuality, a color gamut range other than sample color gamut range 743 cannot be displayed by a display apparatus. Also, as shown in FIG. 18, depending on a lightness default value, color gamut range 746 from display lightness minimum value CIExyY_PEmin 744 to display lightness maximum value CIExyY_PEmax 745 may extend outside of sample color gamut range 743. Therefore, displayable display color gamut range 747 included in sample color gamut range 743, and non-displayable color gamut range 748 not included in sample color gamut range 743, may be present in above-described color gamut range 746, depending on a lightness default value. Furthermore, the size of above-described color gamut range 746 differs according to a lightness default value.

That is to say, the color gamut reproduction ratio (hereinafter referred to as “image quality reproduction ratio”) for a color gamut range that should ideally be covered differs according to a lightness default value. Differing of the image quality reproduction ratio similarly applies to image quality parameters other than lightness.

Thus, an image generation apparatus according to this embodiment finds a default value for which the image quality reproduction ratio becomes largest for each image quality parameter, and uses the found default value. By this means, a decrease in the image quality reproduction ratio accompanying a reduction in the number of generated image elements is suppressed.

The configuration and operation of an image generation apparatus according to this embodiment will now be described. First, the configuration of the image generation apparatus will be described.

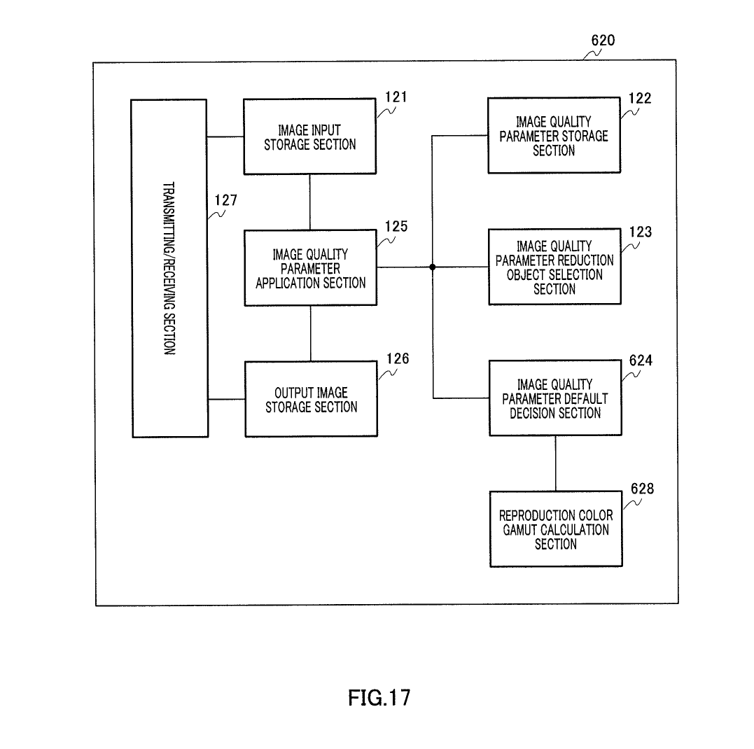

FIG. 17 is a block diagram showing the configuration of an image generation apparatus according to Embodiment 3 of the present invention, corresponding to FIG. 4 of Embodiment 1. Parts in FIG. 17 identical to those in FIG. 4 are assigned the same reference codes as in FIG. 4, and descriptions thereof are omitted here.

In FIG. 17, image generation apparatus 620 has image quality parameter default decision section 624 instead of image quality parameter default decision section 124 in FIG. 4, and additionally has reproduction color gamut calculation section 628.

For each type of display apparatus for which display adjustment is possible, image quality parameter reduction object selection section 123 stores reduction object table 320 in which an image quality parameter for which that display adjustment is possible is entered as a reduction object.

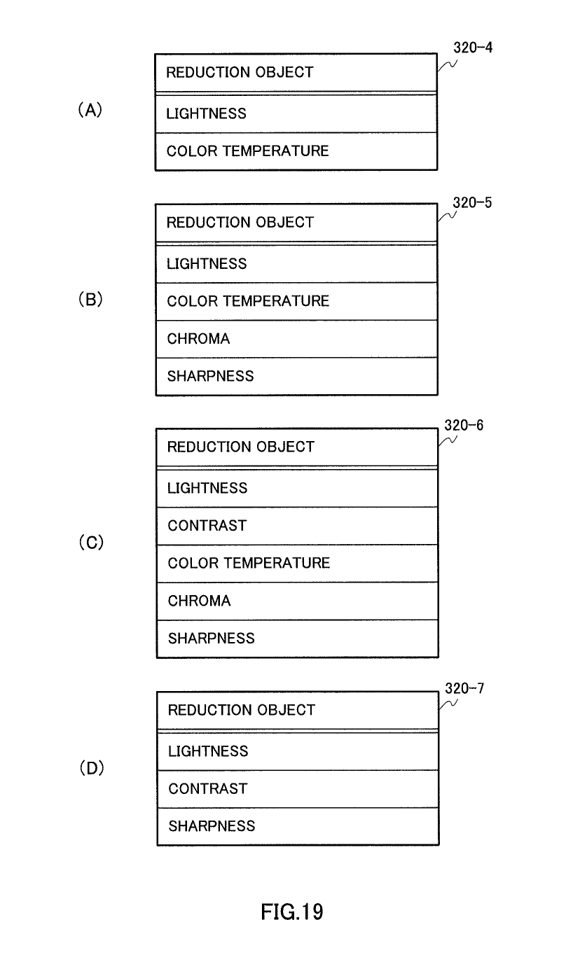

FIG. 19 (A) through FIG. 19 (D) are drawings showing examples of the contents of reduction object tables corresponding to different types of display apparatus, and correspond to FIG. 7 of Embodiment 1.

In reduction object table 320-4 shown in FIG. 19 (A) there are entered reduction objects when a “Manufacturer A” television for which display adjustment is possible for lightness and color temperature is made an image element transmission destination. In reduction object table 320-5 shown in FIG. 19 (B) there are entered reduction objects when a “Manufacturer B” television for which display adjustment is possible for lightness, color temperature, chroma, and sharpness is made an image element transmission destination. In reduction object table 320-6 shown in FIG. 19 (C) there are entered reduction objects when a “Manufacturer C” television for which display adjustment is possible for lightness, contrast, color temperature, chroma, and sharpness is made an image element transmission destination. In reduction object table 320-7 shown in FIG. 19 (D) there are entered reduction objects when a “Manufacturer D” television for which display adjustment is possible for lightness, contrast, and sharpness is made an image element transmission destination.

Thus, reduction object tables 320 stipulate image quality parameters for which adjustment is possible on the display apparatus side.

Using reproduction color gamut calculation section 628, image quality parameter default decision section 624 in FIG. 17 decides a default value to be applied to a reduction object selected by image quality parameter reduction object selection section 123, and outputs the decision result to image quality parameter application section 125

Reproduction color gamut calculation section 628 finds a default value for which a reproduction color gamut becomes maximum for a reduction object—that is, a default value for which the image quality reproduction ratio becomes maximum for each reduction object—by calculation. Then reproduction color gamut calculation section 628 outputs the found default values to image quality parameter default decision section 624 as default values that should be applied to reduction objects. Specifically, reproduction color gamut calculation section 628 stores information relating to a display image quality adjustment range (hereinafter referred to as “adjustment range information”) for each type of display apparatus—that is, associated with reduction object tables 320-1 through 320-4 shown in FIG. 19 (A) through FIG. 19 (D) respectively. Then reproduction color gamut calculation section 628 finds a default value for which the image quality reproduction ratio becomes maximum based on adjustment range information corresponding to a display apparatus type in response to a request from image quality parameter default decision section 624.

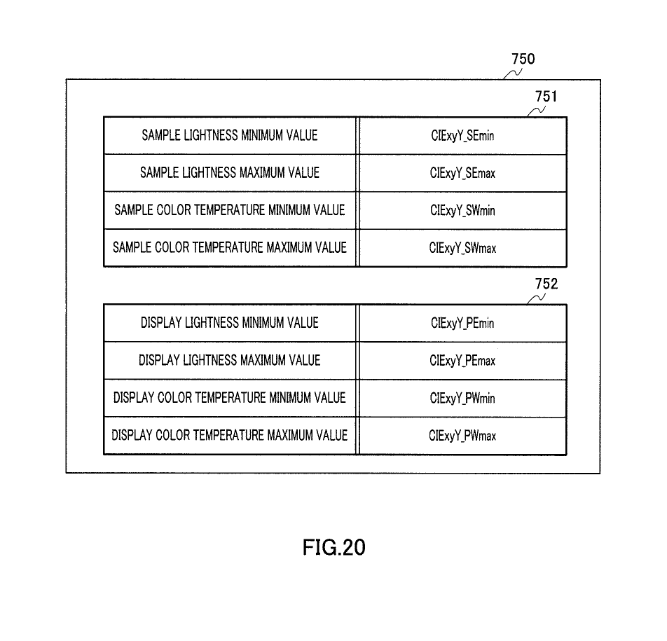

FIG. 20 is a drawing showing an example of the contents of adjustment range information.

As shown in FIG. 20, adjustment range information 750 comprises sample range information 751 and display range information 752. Here, adjustment range information 750 corresponding to reduction object table 320-4 shown in FIG. 19 (A) is shown.

In sample range information 751, sample lightness minimum value CIExyY_SEmin and sample lightness maximum value CIExyY_SWmax illustrated in FIG. 18 are entered. Also entered in sample range information 751 are sample color temperature minimum value CIExyY_SWmin and sample color temperature maximum value CIExyY_SWmax. Sample color temperature minimum value CIExyY_SWmin is an absolute color temperature obtained when an image element generated from a standard image using the minimum value of a color temperature image quality parameter is displayed in a standard image quality setting state of a display apparatus. Sample color temperature maximum value CIExyY_SWmax is an absolute color temperature obtained when an image element generated from a standard image using the maximum value of a color temperature image quality parameter is displayed in a standard image quality setting state of a display apparatus.

That is to say, an image quality adjustment range that is essentially wished to be represented, and for which display is possible by a display apparatus, is entered in sample range information 751.

In display range information 752, display lightness minimum value CIExyY_PEmin and display lightness maximum value CIExyY_PEmax illustrated in FIG. 18 are entered. Also entered in sample range information 752 are display color temperature minimum value CIExyY_PWmin and display color temperature maximum value CIExyY_PWmax. Display color temperature minimum value CIExyY_PWmin is a color temperature obtained as a result of displaying an image element generated by applying a default value to standard-image image data in a state in which a display apparatus setting is made so that color temperature becomes minimum. Display color temperature maximum value CIExyY_PWmax is a color temperature obtained as a result of displaying an image element generated by applying a default value to standard-image image data in a state in which a display apparatus setting is made so that color temperature becomes maximum.

That is to say, a data image quality adjustment range when default values are applied to image data is entered in display range information 752.

It is assumed that a corresponding value is entered in display range information 752 for each default value. That is to say, if, for example, there are ten possible lightness default values “0, 10, 20, 30, 40, 50, 60, 70, 80, 90”, ten values are entered in display lightness minimum value CIExyY_PEmin.

The above numeric values entered in adjustment range information 750 are represented in accordance with a color specification system standard formulated by the International Commission on Illumination (CIE). The color specification system standard formulated by the International Commission on Illumination represents an actual color—including color shade, chroma, and lightness—absolutely by means of a coordinate system called chromaticity. Therefore, by using representations conforming to this standard, even if a display apparatus and display method differ, colors can be identified as being absolutely identical scientifically if their color temperature is the same. CIExyY is one kind of CIE color specification system. In CIExyY, x and y represent chromaticity coordinates excluding lightness, and Y represents lightness. These values can be extracted directly from a display image using a heretofore known colorimeter.

Adjustment range information 750 should preferably store items created based on experimentation, for example, before image generation apparatus 620 is put into actual operation.

Adjustment range information 750 may comprise values indicated by the CIExyY coordinate system as shown in FIG. 20 (chromaticity values), or may use other values. For example, adjustment range information 750 may have a Y value (lightness value) indicating lightness, or may have a K value (Kelvin value) indicating color temperature close to the blackbody locus on the xy coordinates. In these cases, a comparison of numeric value magnitude relationships is easy.

Reproduction color gamut calculation section 628 may convert CIE color specification system values entered in adjustment range information 750 to other values allowing easy comparison of numeric value magnitudes, and use these in comparison computations.

The operation of image generation apparatus 620 having the above-described configuration will now be explained in detail.

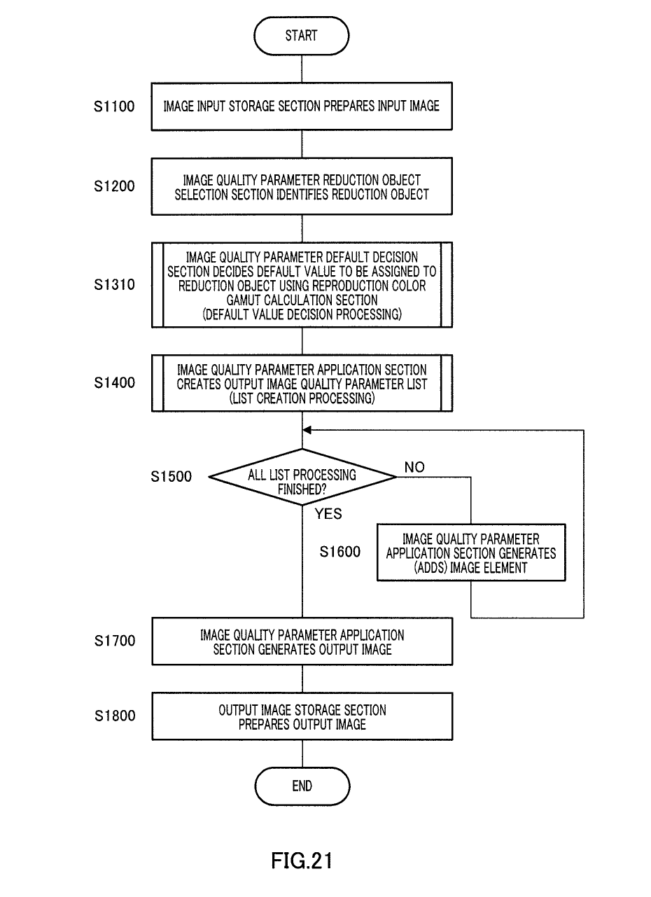

FIG. 21 is a flowchart showing an example of the operation flow of image generation apparatus 620 from reception of image collection 221 and image quality parameter information 223 to preview image switching and display, corresponding to FIG. 9 of Embodiment 1. Parts in FIG. 21 identical to those in FIG. 9 are assigned the same step numbers as in FIG. 9, and descriptions thereof are omitted here.

In step S1310, instead of step S1300 of FIG. 9, image quality parameter default decision section 624 decides a default value to be assigned to a reduction object using reproduction color gamut calculation section 628. The processing executed by reproduction color gamut calculation section 628 will now be described as default value decision processing, using a separate drawing.

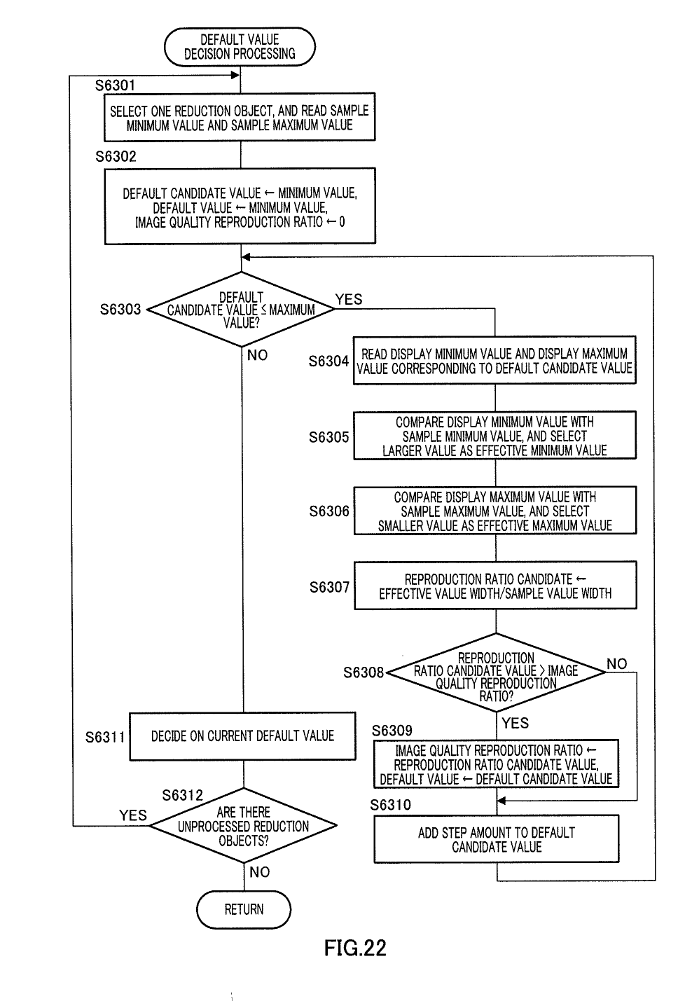

FIG. 22 is a flowchart showing an example of the flow of default value decision processing by reproduction color gamut calculation section 628 (step S1310 in FIG. 21).

First, in step S6301, reproduction color gamut calculation section 628 selects one reduction object, and reads a corresponding sample minimum value and sample maximum value from adjustment range information 750.

Then, in step S6302, reproduction color gamut calculation section 628 sets the minimum value of possible values for a default candidate value and default value as an initial value, and sets the image quality reproduction ratio to 0.

A default value here is a variable for deciding a default value that should be applied to a selected reduction object, and is a temporary storage location of a default value that should be applied to a selected reduction object. A default candidate value is a variable for use in switching and calculation of a possible default value, and is a temporary storage location for finally obtaining a default value. An image quality reproduction ratio here is a numeric value for comparing the image quality reproduction ratio magnitudes of each default candidate value, and is a location for temporarily storing a reproduction color gamut cover ratio—that is, what image quality reproduction ratio can be obtained—at that time.

Next, in step S6303, reproduction color gamut calculation section 628 determines whether or not the current default candidate value is less than or equal to the maximum possible default value for the selected reduction object. If the current default candidate value is less than or equal to the maximum value (S6303: YES), reproduction color gamut calculation section 628 proceeds to step S6304. In the initial state, the default candidate value is a minimum value, and therefore reproduction color gamut calculation section 628 always proceeds to step S6304.

In step S6304, reproduction color gamut calculation section 628 references adjustment range information 750, and reads a display minimum value and display maximum value corresponding to the current default candidate value for the selected reduction object.

Then, in step S6305, reproduction color gamut calculation section 628 compares the display minimum value read in step S6304 with the sample minimum value read in step S6301, and selects the larger value as an effective minimum value if the values are different, or, if the values are the same, selects that value as an effective minimum value. That is to say, an effective minimum value is the minimum value of an effective value of a relevant image quality parameter in a display apparatus when the current default candidate value is applied as a default value of a selected reduction object.

Next, in step S6306, reproduction color gamut calculation section 628 compares the display maximum value read in step S6304 with the sample maximum value read in step S6301, and selects the smaller value as an effective maximum value if the values are different, or, if the values are the same, selects that value as an effective maximum value. That is to say, an effective maximum value is the maximum value of an effective value of a relevant image quality parameter in a display apparatus when the current default candidate value is applied as a default value of a selected reduction object.

Then, in step S6307, reproduction color gamut calculation section 628 calculates a value resulting from dividing the effective value width by the sample value width, and stores the calculated value as a reproduction ratio candidate value. A reproduction ratio candidate value is a variable for storing a value that becomes an image quality reproduction ratio candidate, and is a temporary storage location of the maximum value of an image quality reproduction ratio at that point in time. Reproduction color gamut calculation section 628 actually calculates a reproduction ratio candidate value using Equation (1) below, for example.

Reproduction ratio candidate value=effective value width/sample value width=(effective maximum value−effective minimum value)/(sample maximum value−sample minimum value) (1)

Next, in step S6308, reproduction color gamut calculation section 628 determines whether or not the current reproduction ratio candidate value is greater than the current image quality reproduction ratio. Reproduction color gamut calculation section 628 proceeds to step S6309 if the current reproduction ratio candidate value is greater than the current image quality reproduction ratio (S6308: YES), or proceeds to step S6310, the step after step S6309, if the current reproduction ratio candidate value is less than or equal to the current image quality reproduction ratio (S6308: NO).

In step S6309, reproduction color gamut calculation section 628 sets the current reproduction ratio candidate value as an image quality reproduction ratio, sets the current default candidate value as a default value, and proceeds to step S6310.

In step S6310, reproduction color gamut calculation section 628 adds a step amount stipulated in adjustment range table 310 (see FIG. 6) to the default candidate value, and returns to step S6303.

That is to say, if a reproduction ratio candidate value higher than any reproduction ratio candidate value in past default candidate values is obtained in the process of changing a default candidate value from a minimum value to a maximum value, that reproduction ratio candidate value and default candidate value are set as an image quality reproduction ratio and a default value respectively. Therefore, a value finally set as a default value after repeating steps S6303 through S6310 is a default value for which the image quality reproduction ratio is maximum. Reproduction color gamut calculation section 628 repeats steps S6303 through S6310, and when the current default candidate value finally exceeds the maximum value (S6303: NO), proceeds to step S6311.

In step S6311, reproduction color gamut calculation section 628 decides a default value that should be applied to the selected reduction object to be the current default value, and passes the decision result to image quality parameter default decision section 624.

Then, in step S6312, reproduction color gamut calculation section 628 determines whether or not there are unprocessed reduction objects. If there are unprocessed reduction objects (S6312: YES), reproduction color gamut calculation section 628 returns to step S6301, selects an unprocessed reduction object, and repeats the processing. When default values have been decided for all reduction objects (S6312: NO), reproduction color gamut calculation section 628 returns to the processing in FIG. 21.

In this way, a value for which the image quality reproduction ratio is highest is decided upon as a default value to be applied to a reduction object. A color gamut actually implemented by a display apparatus is one in which respective effective value regions are applied to image quality parameters. Therefore, by means of the above-described default value decision processing, default values for which a reproduction color gamut is widest are decided for reduction objects.

The actual processing flow in default value decision processing will now be described, taking a case in which a selected reduction object is lightness as an example.

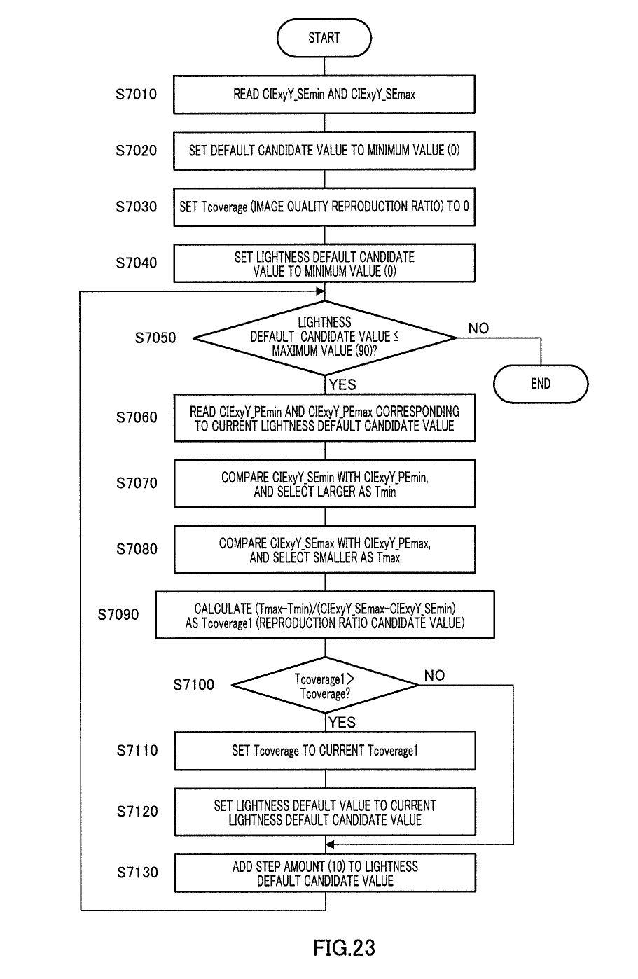

FIG. 23 is a flowchart showing an example of the actual processing flow in steps S6301 through S6311 of default value decision processing when a reduction object is lightness.

First, in step S7010, reproduction color gamut calculation section 628 reads sample lightness minimum value CIExyY_SEmin and sample lightness maximum value CIExyY_SEmax from adjustment range information 750 (see FIG. 20).

Then, in steps S7020 through S7040, reproduction color gamut calculation section 628 sets minimum value 0 stipulated in adjustment range table 310 for both a default candidate value and a default value, and also sets 0 for Tcoverage indicating a lightness image quality reproduction ratio.

Next, in step S7050, reproduction color gamut calculation section 628 determines whether or not the lightness default candidate value is less than or equal to maximum value 90 stipulated in adjustment range table 310, and if the lightness default candidate value is less than or equal to maximum value 90 (S7050: YES), proceeds to step S7060.

In step S7060, reproduction color gamut calculation section 628 reads a value corresponding to the current default candidate value from among display lightness minimum value CIExyY_PEmin and display lightness maximum value CIExyY_PEmax from adjustment range information 750 (see FIG. 20).

Then, in step S7070, reproduction color gamut calculation section 628 compares a value corresponding to the current default candidate value among display lightness minimum values CIExyY_PEmin with sample lightness minimum value CIExyY_SEmin, and decides the larger to be effective minimum value Tmin.

Next, in step S7080, reproduction color gamut calculation section 628 compares a value corresponding to the current default candidate value among display lightness maximum values CIExyY_PEmax with sample lightness maximum value CIExyY_SEmax, and decides the smaller to be effective maximum value Tmax.

Then, in step S7090, reproduction color gamut calculation section 628 calculates Tcoverage1, which is a lightness reproduction ratio candidate value. Reproduction color gamut calculation section 628 finds Tcoverage1 by means of the calculation in Equation (2) below, for example.

Tcoverage1=(Tmax−Tmin)/(CIExyY_SEmax−CIExyY_SEmin) (2)

Next, in step S7100, reproduction color gamut calculation section 628 determines whether or not lightness reproduction ratio Tcoverage is greater than lightness reproduction ratio candidate value Tcoverage1. Reproduction color gamut calculation section 628 proceeds to step S7110 if Tcoverage is greater than Tcoverage1 (S7100: YES), or proceeds to step S7130 if Tcoverage is less than or equal to Tcoverage1 (S7100: NO).

In step S7110, reproduction color gamut calculation section 628 sets current lightness reproduction ratio candidate value Tcoverage1 as lightness reproduction ratio Tcoverage.

Then, in step S7120, reproduction color gamut calculation section 628 sets the current lightness default candidate value as a lightness default value.

Next, in step S7130, reproduction color gamut calculation section 628 adds step amount 10 stipulated in adjustment range table 310 (see FIG. 6) to the lightness default candidate value, and returns to step S7050.

When reproduction color gamut calculation section 628 has repeated the above-described processing of steps S7050 through S7130 a number of times equal to the number of lightness value choices—that is, ten times—the lightness default candidate value exceeds lightness maximum value 90, and therefore reproduction color gamut calculation section 628 terminates the series of processing steps.

Thus, according to this embodiment, a reproduction color gamut of a display apparatus that displays an output image as a preview image is calculated by calculating an effective value width for default candidate values, and a default value for which the reproduction color gamut is maximum is applied to a reduction object. By this means, even if color gamut loss occurs due to a reduction in image quality parameters, a lost color gamut is reproduced as far as possible, and it is possible to come close to restoration of an original reproduction color gamut when image quality parameters are not reduced. Therefore, compared with a case in which image quality parameter reduction is restricted so as to prevent color gamut loss, the number of generated image elements can be reduced, and the time from input image 210 reception to preview image display can be further shortened.

### Embodiment 4

In Embodiment 4, at least some image quality adjustment choices that should be presented as preview images based on actual user image quality specification information is implemented with display adjustment on the image display apparatus side.

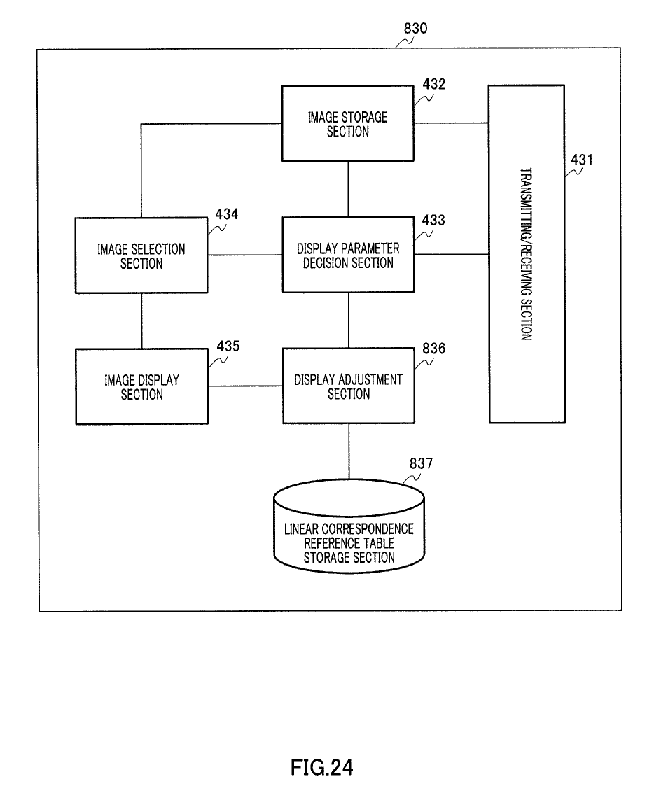

FIG. 24 is a block diagram showing a configuration of an image display apparatus according to Embodiment 4 of the present invention, corresponding to FIG. 12 of Embodiment 2. Parts in FIG. 24 identical to those in FIG. 12 are assigned the same reference codes as in FIG. 12, and descriptions thereof are omitted here.

In FIG. 24, image display apparatus 830 has display adjustment section 836 instead of display adjustment section 436 in FIG. 12, and additionally has linear correspondence reference table storage section 837.

Linear correspondence reference table storage section 837 stores linear correspondence reference tables that are associated with image quality adjustment content choices, and in which association is provided with display adjustment content that displays a preview image with image quality equivalent to image quality when that image quality adjustment content is applied.

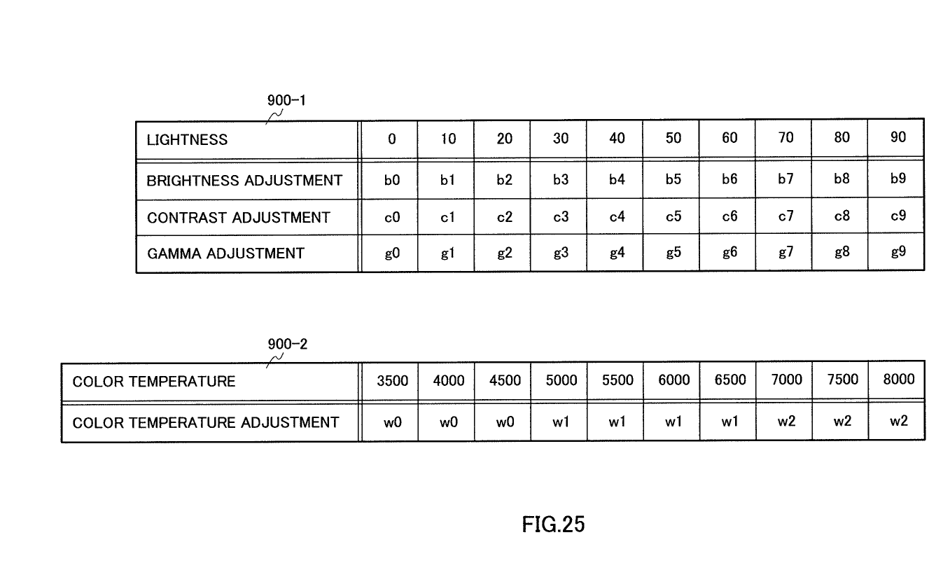

FIG. 25 is a drawing showing the contents of linear correspondence reference tables stored in linear correspondence reference table storage section 837. Only a linear correspondence reference table corresponding to lightness and a linear correspondence reference table corresponding to color temperature are shown here.

As shown in FIG. 25, in linear correspondence reference tables 900, adjustment content for each adjustment item is entered, associated with possible values as an image quality parameter. Adjustment content entered for each adjustment item is adjustment content that displays a preview image with image quality identical or similar to image quality when a corresponding value is set for an image quality parameter when all adjustment contents of each adjustment item are applied. Specifically, actual adjustment values of parameters provided in image display. apparatus 830 for display adjustment, for example, are entered in each adjustment item.

In linear correspondence reference table 900-1 corresponding to lightness, adjustment contents are entered respectively for a plurality of adjustment items called brightness adjustment, contrast adjustment, and gamma adjustment, associated with possible values for brightness.

Brightness adjustment is an adjustment item used for brightness adjustment of the center of a dark section of a television. Contrast adjustment is an adjustment item used for brightness adjustment of the center of a bright section. Gamma adjustment is an adjustment item used for brightness adjustment of the center of an intermediate section.

For example, “b5”, “c5”, and “g5” are associated with lightness “50” as brightness adjustment, contrast adjustment, and gamma adjustment respectively. This indicates that, in order to display a preview image at lightness 50, the adjustment contents of brightness adjustment, contrast adjustment, and gamma adjustment should be made b5, c5, and g5 respectively.

A case has been illustrated here by way of example in which display adjustment contents of three kinds of adjustment item—brightness adjustment, contrast adjustment, and gamma adjustment—are stipulated as corresponding to lightness, but this is not a limitation, and stipulations can be made for any display adjustment for which display adjustment is possible by image display apparatus 830.

In linear correspondence reference table 900-2 corresponding to color temperature, adjustment contents are entered for an adjustment item called color temperature adjustment, associated with possible values for color temperature.

For example, “w1” is associated with color temperature “6500” as adjustment content for color temperature adjustment. This indicates that, in order to display a preview image at color temperature 6500, the adjustment content of color temperature adjustment should be made w1.

Actual adjustment values stored in linear correspondence reference tables 900 can be obtained, for example, by displaying a standard image described in Embodiment 4 in image display section 435, and measuring the displayed chromaticity. Linear correspondence reference table 900 adjustment values may be found, for example, by carrying out measurements for each image display apparatus 830 unit before shipment, and obtaining values from the results of those measurements. Alternatively, if there is commonality in the results for adjustment values for the same model, provision may be made for measurements to be carried out beforehand using a sample unit, and for values based on those measurement results to be used uniformly for the same model.

Display adjustment section 836 in FIG. 24 acquires display adjustment content based on image quality specification information reported from display parameter decision section 433. Specifically, display adjustment section 836 acquires display adjustment content corresponding to image quality adjustment content specified by image quality specification information. Then display adjustment section 836 performs preview image display adjustment in accordance with the acquired image quality adjustment content.

The operation of image display apparatus 830 according to this embodiment will now be explained.

On receiving image collection 221 and image quality parameter information 223 from image generation apparatus 120 shown in FIG. 3, for example, image display apparatus 830 decides used parameter information and a preview use image and displays the preview use image, as illustrated in FIG. 16. In this embodiment, used parameter information is not used by display adjustment section 836, and therefore reporting of used parameter information to display adjustment section 836 from display parameter decision section 433 need not be performed.

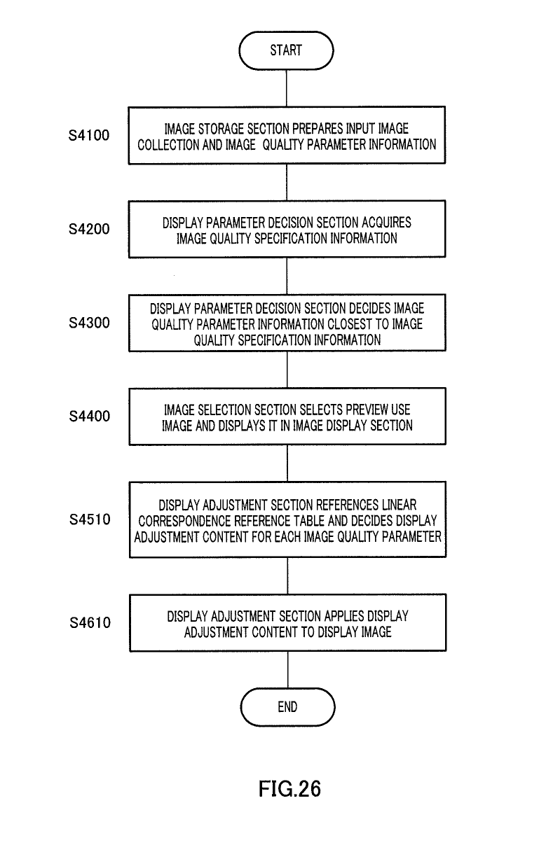

FIG. 26 is a flowchart showing an example of the operation flow of image display apparatus 830 from image collection 221 and image quality parameter information 223 reception to preview image switching and display, corresponding to FIG. 16 of Embodiment 2. Parts in FIG. 26 identical to those in FIG. 16 are assigned the same step numbers as in FIG. 16, and descriptions thereof are omitted here.

Having received an image quality specification information report from display parameter decision section 433, display adjustment section 836 performs step S4510 processing instead of step S4500 processing.

In step S4510, display adjustment section 836 references linear correspondence reference tables 900 and decides display adjustment content for each image quality parameter type. Specifically, for each image quality parameter type, display adjustment section 836 acquires a value of each adjustment item corresponding to an image quality specification information value from linear correspondence reference table 900, and decides display adjustment content from the acquired adjustment content. If there are a plurality of adjustment items, a combination of a plurality of adjustment contents becomes the decided display adjustment content.

Then, in step S4610, display adjustment section 836 performs display-image image quality adjustment by applying the acquired display adjustment content to a display image. As a result, preview image display image quality is also adjusted.

Thus, according to this embodiment, linear correspondence reference tables in which display adjustment contents having an effect identical to an effect had on preview image display image quality by image quality parameter values are entered are stored beforehand. Then these linear correspondence reference tables are referenced and display adjustment contents corresponding to user-specified image quality parameter values are applied to a preview image. By this means, even if there is no image element having image quality corresponding to user-specified image quality adjustment content, a preview image of similar image quality to that obtained by means of user-specified image quality adjustment content can be displayed. Also, since a similar preview image can be displayed even if there is no image element having image quality corresponding to user-specified image quality adjustment content, the necessary number of image elements can be reduced, and a preview image can be displayed from an input image in a shorter time.

In above-described Embodiments 1 and 3, it has been assumed that an image element forming the basis of a preview image is generated from input image 210 by image generation apparatus 120/620, but this is not a limitation. For example, provision may be made for image generation apparatus 120/620 to generate an image element from an image resulting from reducing input image 210, and for target image 240 to be generated from unreduced original input image 210. By this means, higher processing speed and higher target image 240 quality can both be achieved. Also, provision may be made for an image element to be generated using editing processing for input image 210 that is identical to editing processing used in target image 240 generation, and furthermore for an image element itself to be presented to a user as target image 240.

Moreover, image quality specification information may be image quality adjustment content itself rather than information indicating image quality adjustment content. In this case, it is not necessary for image generation apparatus 120/620 to associate a generated image element with image quality adjustment content.

In the above-described embodiments, an image display apparatus has been described as a television, but this is not a limitation. For example, the present invention can of course be applied to various devices capable of image-data image display and input operations, such as personal computers, portable information terminals, mobile phones, portable game machines, and the like, as well as various devices capable of performing display-image image quality adjustment.

Furthermore, a configuration may be used in which an image generation apparatus and an image display apparatus are provided in an integrated fashion. In this case, the time necessary for information transfer between these devices is shortened, and the maximum time required until a preview image is displayed from image data can be further shortened.

The disclosure of Japanese Patent Application No.2007-204808, filed on Aug. 6, 2007, including the specification, drawings and abstract, is incorporated herein by reference in its entirety.

### INDUSTRIAL APPLICABILITY

An image generation apparatus, image display apparatus, image generation method, image display method, image generation program, and image display program according to the present invention are suitable for use in computers and AV (audio-visual) devices such as servers, computer devices, Net TVs, set-top boxes, and the like, that enable the maximum time required until a preview image is displayed to be shortened without narrowing the image quality adjustment selection range insofar as this is possible.

1. An image generation apparatus comprising:
an image quality adjustment selection section that selects at least one image quality adjustment content from among a preset plurality of image quality adjustment contents;
an image quality adjustment application section that applies image quality adjustment content selected by the image quality adjustment selection section to provided image data and performs image quality adjustment of that image data; and
a transmitting section that transmits image data on which image quality adjustment has been performed by the image quality adjustment application section to an image display apparatus,
wherein the image quality adjustment selection section, when at least two of image data on which image quality adjustment has been performed by applying the plurality of image quality adjustment contents can be displayed with identical or similar image quality by the image display apparatus, selects only one image quality adjustment content from image quality adjustment contents applied to that image data.

2. The image generation apparatus according to claim 1, wherein:
the image quality adjustment content is defined by a combination of a plurality of image quality parameter values for each of which a maximum adjustment range is set; and
the image quality adjustment selection section selects a default adjustment range narrower than that maximum adjustment range for an image quality parameter for which supplementation of corresponding image quality adjustment content is possible by display adjustment in the image display apparatus, and selects that maximum adjustment range for another image quality parameter.

3. The image generation apparatus according to claim 2, wherein the image quality parameter is a parameter for adjusting at least one or a plurality of combinations of lightness, contrast, chroma, color temperature, sharpness, and noise reduction.

4. The image generation apparatus according to claim 2, further comprising an image quality parameter default decision section that decides the default adjustment range of an image quality parameter for which supplementation of corresponding image quality adjustment content is possible, for each type of the image display apparatus.

5. The image generation apparatus according to claim 2, further comprising a reproduction color gamut calculation section that, from a sample color gamut range that is measured values of a color gamut range when image data of a standard image on which image quality adjustment has been performed by applying a maximum adjustment range of an image quality parameter, and a plurality of display color gamut ranges for each candidate of the default adjustment range that are measured values of a color gamut range when image data of the standard image on which image quality adjustment has been performed by applying that adjustment range of an image quality parameter, calculates a size of a range in which the sample color gamut range and the plurality of display color gamut ranges overlap,
wherein the image quality parameter default decision section decides a candidate of the default adjustment range corresponding to a display color gamut range for which a value calculated by the reproduction color gamut calculation section is maximum as the default adjustment range.

6. An image display apparatus comprising:
a receiving section that receives image data transmitted from the image generation apparatus according to claim 1;
an adjustment content decision section that decides image quality adjustment content that should be applied to image data received by the receiving section from among the plurality of image quality adjustment contents;
a display adjustment section that, when the receiving section has not received image data on which image quality adjustment has been performed by applying image quality adjustment content decided by the adjustment content decision section, performs display adjustment on image data received by the receiving section by applying display adjustment content displays with image quality identical or similar to image quality when image quality adjustment is performed by applying image quality adjustment content decided by the adjustment content decision section; and
an image display section that displays image data that has undergone display adjustment by the display adjustment section.

7. The image display apparatus according to claim 6, wherein:
the image quality adjustment content is defined by a combination of a plurality of image quality parameter values for each of which a maximum adjustment range is set; and
the display adjustment selection section decides display adjustment content to be applied to the image data based on a difference between a value of an image quality parameter applied to image data received by the receiving section and a value of the image quality parameter decided by the adjustment content decision section.

8. The image display apparatus according to claim 7, wherein the image quality parameter is a parameter that adjusts at least one or a plurality of combinations of lightness, contrast, chroma, color temperature, sharpness, and noise reduction.

9. The image display apparatus according to claim 7, wherein the adjustment content decision section accepts decision input of a value of the image quality parameter by a user operation.

10. The image display apparatus according to claim 7, further comprising an image storage section that stores image data received by the receiving section,
wherein the adjustment content decision section decides image data to which a value of an image quality parameter for which a difference from a value of the parameter decided by the adjustment content decision section is smallest as a display object of the image display section.

11. The image display apparatus according to claim 6, further comprising a table storage section that stores, associated with a value of an image quality parameter, a linear correspondence reference table in which is entered display adjustment content that displays with image quality identical or similar to image quality when that value is applied,
wherein the display adjustment section references the linear correspondence reference table, and decides display adjustment content corresponding to a value of an image parameter decided by the adjustment content decision section as display adjustment content to be applied to the image data.

12. An image generation method comprising:
selecting at least one image quality adjustment content from among a preset plurality of image quality adjustment contents;
an image quality adjustment application applying image quality adjustment content selected in the image quality adjustment selection to provided image data and performing image quality adjustment of that image data; and
a transmitting image data on which image quality adjustment has been performed in the image quality adjustment application to an image display apparatus,
wherein the image quality adjustment selection, when at least two of image data on which image quality adjustment has been performed by applying the plurality of image quality adjustment contents can be displayed with identical or similar image quality by the image display apparatus, selects only one image quality adjustment content from image quality adjustment contents applied to that image data.

13. An image display method comprising:
a receiving image data transmitted from the image generation apparatus according to claim 1;
deciding image quality adjustment content that should be applied to image data received in the receiving from among the plurality of image quality adjustment contents;
adjusting a display, when image data on which image quality adjustment has been performed, by applying image quality adjustment content decided in the adjustment content decision has not been received in the receiving, performing display adjustment on image data received in the receiving by applying display adjustment content displays with image quality identical or similar to image quality when image quality adjustment is performed by applying image quality adjustment content decided in the adjustment content decision; and
displaying image data that has undergone display adjustment in the display adjustment step.

14. A computer readable medium having an image generation program that causes a computer to execute:
image quality adjustment selection processing that selects at least one image quality adjustment content from among a preset plurality of image quality adjustment contents;
image quality adjustment application processing that applies image quality adjustment content selected by the image quality adjustment selection processing to provided image data and performs image quality adjustment of that image data; and
transmitting processing that transmits image data on which image quality adjustment has been performed by the image quality adjustment application processing to an image display apparatus,
wherein the image quality adjustment selection processing, when at least two of image data on which image quality adjustment has been performed by applying the plurality of image quality adjustment contents can be displayed with identical or similar image quality by the image display apparatus, selects only one image quality adjustment content from image quality adjustment contents applied to that image data.

15. A computer readable medium having an image display program that causes a computer to execute:
receiving processing that receives image data transmitted from the image generation apparatus according to claim 1;
adjustment content decision processing that decides image quality adjustment content that should be applied to image data received by the receiving processing from among the plurality of image quality adjustment contents;
display adjustment processing that, when image data on which image quality adjustment has been performed by applying image quality adjustment content decided by the adjustment content decision processing has not been received by the receiving processing, performs display adjustment on image data received by the receiving processing by applying display adjustment content displays with image quality identical or similar to image quality when image quality adjustment is performed by applying image quality adjustment content decided by the adjustment content decision processing; and
image display processing that displays image data that has undergone display adjustment by the display adjustment processing.
